(19) United States
(12) Patent Application Publication
(10) Pub. No.: US 2009/0163275 A1
(43) Pub. Date: Jun. 25, 2009

(54) Method of controlling movement of moving object, storage medium, and game device

(75) Inventors: Kentaro ISHII, Kanagawa (JP); Tomohiro MAKI, Tokyo (JP); Tamaki NODA, Tokyo (JP); Ryouichi KIKUCHI, Funabashi-shi (JP)

Correspondence Address: OLIFF & BERRIDGE, PLC, P.O. BOX 320850, ALEXANDRIA, VA, 22320-4850, US

(73) Assignee: NAMCO BANDAI Games Inc., Tokyo (JP)

(21) Appl. No.: 12/332,933

(22) Filed: Dec. 11, 2008

(30) Foreign Application Priority Data
Dec. 14, 2007 (JP) 2007-324087

(51) Int. Cl. A63F 13/00; A63F 9/24

(52) U.S. Cl. 463/31; 463/37; 463/35

(57) ABSTRACT

A player brings a stylus pen into contact with a pitching position mark displayed on a second liquid crystal display that includes a touch panel, inputs a ball speed by adjusting a touch position holding time, and inputs a pitching start timing and a pitching direction by inputting a first stroke operation along the direction of a pitching direction guide. When the player desires to change the path of a pitched ball, the player inputs a ball path change direction by inputting a second stroke operation sideways after the first stroke operation.

Japanese Patent Application No. 2007-324087 filed on Dec. 14, 2007, is hereby incorporated by reference in its entirety.

### BACKGROUND

A baseball game that allows the player to select a team and play a match against a computer-controlled team or a team of another player is a popular video game. A game screen of the baseball game generally has a configuration in which the pitcher's mound is viewed across the catcher. When the player's team plays defense, player characters of the player's team are disposed as the pitcher and the catcher, and a player character of the opposing team is disposed within the batter's box. When the player's team plays offense, a player character of the player's team is disposed within the batter's box, and player characters of the opposing team are disposed as the pitcher and the catcher.

When the player's team plays defense, the player inputs a pitching operation such as the pitch, the ball speed, the pitching direction, and the pitching start timing by operating an arrow key and a button switch of a game controller. When the player's team plays offense, the player inputs the batting (hitting or bunt) start timing, the hitting direction, and the like at an appropriate timing by operating the arrow key and the button switch while watching an image in which a ball pitched by the pitcher of the opposing team travels toward the batter.

In recent years, a game device provided with a touch panel has been put on the market. A baseball game that allows the player to input a pitching operation utilizing a touch panel (see Japanese Patent No. 3866752, for example) and a baseball game that allows the player to input a batting operation utilizing a touch panel (see Japanese Patent No. 3822215, for example) have been known.

According to the technology disclosed in Japanese Patent No. 3866752, the player can input a pitching operation by performing a stroke operation on the touch panel. For example, when the player inputs a stroke operation along a given path, the ball speed is changed based on the speed of the stroke operation.

The player must input a large number of pitching operations when playing a game. When using the operation input method disclosed in Japanese Patent No. 3866752, the player must input a stroke operation along a given path each time the player inputs a pitching operation, and repeat an operation input at a stroke speed corresponding to the desired ball speed. Therefore, the player may consider the operation input to be troublesome. Moreover, the game process may take time.

### SUMMARY

According to one aspect of the invention, there is provided a method comprising:

determining start of a stroke operation performed on a touch panel;

determining a magnitude of an operation input based on a time elapsed until the stroke operation is performed after a touch operation has been performed on the touch panel;

determining a direction based on the stroke operation; and

controlling movement of a given moving object displayed on a screen using the determined magnitude and the determined direction.

According to another aspect of the invention, there is provided a method comprising:

displaying a touch start position indicator on a display section that includes a touch panel;

determining a magnitude of an operation input based on a moving path of a touch position within the touch start position indicator;

determining start of a stroke operation performed on the touch panel;

determining a direction based on the stroke operation; and

controlling movement of a given moving object displayed on a screen using the determined magnitude and the determined direction.

### BRIEF DESCRIPTION OF THE DRAWINGS

FIG. 1 is a view showing a configuration example of a portable game device.

FIGS. 2A and 2B are views showing examples of a game screen and a pitching operation input screen when the player's team plays defense.

FIGS. 3A and 3B are views illustrative of a pitching operation input process.

FIG. 4 is a view illustrative of a pitching operation input process.

FIGS. 5A and 5B are views showing examples of a game screen and a batting operation input screen when the player's team plays offense.

FIGS. 6A and 6B are views illustrative of a batting operation input process.

FIG. 7 is a view illustrative of a batting operation input process.

FIG. 8 is a view illustrative of a bunt operation input method.

FIG. 9 is a functional block diagram showing an example of the functional configuration according to a first embodiment.

FIG. 10 is a view showing a data configuration example of pitching parameters.

FIG. 11 is a view showing a data configuration example of batting parameters.

FIG. 12 is a flowchart illustrative of the flow of the main processes according to the first embodiment.

FIG. 13 is a flowchart illustrative of the flow of a pitching operation determination process according to the first embodiment.

FIG. 14 is a flowchart illustrative of the flow of the main processes according to the first embodiment.

FIG. 15 is a flowchart illustrative of the flow of a batting operation determination process according to the first embodiment.

FIGS. 16A to 16D are views illustrative of a pitching operation method according to a second embodiment.

FIG. 17 is a flowchart illustrative of the flow of a pitching operation determination process B according to the second embodiment.

FIGS. 18A to 18E are views illustrative of a pitching operation method according to a third embodiment.

FIG. 19 is a flowchart illustrative of the flow of a pitching operation determination process C according to the third embodiment.

FIG. 20 is a view illustrative of a modification of a bunt operation input method.

FIG. 21 is a flowchart illustrative of the flow of a batting operation determination process B.

FIG. 22 is a flowchart illustrative of the flow of a batting operation determination process C.

FIG. 23 shows a screen example that displays a magnitude value determined based on an operation input performed on a touch panel.

FIG. 24 is a functional block diagram showing a functional configuration example that outputs sound based on a magnitude value determined based on an operation input performed on a touch panel.

FIG. 25 is a perspective external view showing a configuration example of an arcade game device that includes a touch panel.

FIG. 26 is a view showing a display example when displaying a pitching operation input screen on a game screen.

FIG. 27 is a flowchart illustrative of the flow of a pitched ball position calculation process.

### DESCRIPTION OF EXEMPLARY EMBODIMENTS

The invention may implement an easy and intuitive operation input using a touch panel in a game that controls the movement of a moving object.

According to one embodiment of the invention, there is provided a method comprising:

displaying a touch start position indicator on a display section that includes a touch panel;

determining a magnitude of an operation input based on a moving path of a touch position within the touch start position indicator;

determining start of a stroke operation performed on the touch panel;

determining a direction based on the stroke operation; and

controlling movement of a given moving object displayed on a screen using the determined magnitude and the determined direction.

According to another embodiment of the invention, there is provided a game device comprising:

a stroke start determination section that determines start of a stroke operation performed on a touch panel;

a magnitude determination section that determines a magnitude of an operation input based on a time elapsed until the stroke operation is performed after a touch operation has been performed on the touch panel;

a direction determination section that determines a direction based on the stroke operation; and

a movement control section that controls movement of a given moving object displayed on a screen using the determined magnitude and the determined direction.

The term “moving object” used herein includes a ball used in a baseball game or a soccer game, a throwing-knife, a tennis ball, a missile, a bird, an airplane, and the like.

According to the above configuration, the magnitude of the operation input can be determined based on the time elapsed until the stroke operation is performed after the touch operation has been performed on the touch panel, and the direction of the operation input can be determined based on the stroke operation. The movement of the moving object can be controlled based on the magnitude and the direction. Specifically, movement control of the moving object can be input by a simple operation that maintains the touch position until the desired magnitude is reached and then performs the stroke operation. Moreover, since the ball speed is not determined based on the speed of the stroke operation, the operation input can be implemented by an easy operation.

Note that the expression “maintains the touch position” does not mean that the first touch position is maintained strictly, but allows a change in position that may occur when the player maintains the touch position for a given period of time.

In the method,

the controlling of the movement of the moving object may include variably controlling a moving speed of the moving object based on the determined magnitude.

According to the above configuration, since the moving speed of the moving object can be set based on the position holding time from the touch operation to the start of the stroke operation, the above configuration is suitable for an operation input that launches or hits a moving object (e.g., pitching in a baseball game or kick in a soccer game).

The method may further comprise:

determining that the stroke operation has started when a touch position has changed in an amount outside a given allowable range.

According to the above configuration, since the start of the stroke operation is determined when the touch position has moved in an amount outside the allowable range, the degree of association with the motion of the character in the game (e.g., pitching arm motion or kick motion) is increased by setting an appropriate value that reminds the player of an operation that biases the moving object as the allowable range. Therefore, a more intuitive and realistic operation input method can be implemented.

The method may further comprise:

determining a second direction based on a touch position after the stroke operation has started; and

changing a moving direction of the moving object to the second direction.

The method may further comprise:

determining the second direction based on a change direction of the touch position after the stroke operation has started.

The method may further comprise:

changing the second direction based on an amount of change in the touch position after the stroke operation has started.

The method may further comprise:

determining the second direction based on the touch position when the touch position is situated at an approximately identical position for a given period of time after the stroke operation has started.

According to the above configuration, the moving path of the moving object can be changed by allowing the touch position to remain at an approximately identical position for a given period of time after starting the stroke operation. The movement of the moving object can be input by a series of operations from the touch start operation.

The method may further comprise:

determining a degree of change in the moving direction of the moving object to the second direction using the determined magnitude.

According to the above configuration, the degree of change in the moving direction of the moving object to the second direction can be input by a series of operations without increasing the number of operation inputs.

The method may further comprise:

displaying a display object that indicates the determined magnitude.

According to the above configuration, since the player can determine the magnitude of the operation input, operability can be improved.

The method may further comprise:

variably outputting effect sound based on the determined magnitude.

According to the above configuration, the player can determine the magnitude of the operation input performed on the touch panel by means of effect sound. Therefore, the player can easily master the stroke operation for obtaining the desired magnitude, and aurally determine the magnitude input by the player.

According to another embodiment of the invention, there is provided a method comprising:

displaying a touch start position indicator on a display section that includes a touch panel;

determining a magnitude of an operation input based on a moving path of a touch position within the touch start position indicator;

determining start of a stroke operation performed on the touch panel;

determining a direction based on the stroke operation; and

controlling movement of a given moving object displayed on a screen using the determined magnitude and the determined direction.

According to another embodiment of the invention, there is provided a game device comprising:

a touch start position indicator display control section that displays a touch start position indicator on a display section that includes a touch panel;

a magnitude determination section that determines a magnitude of an operation input based on a moving path of a touch position within the touch start position indicator;

a stroke start determination section that determines start of a stroke operation performed on the touch panel;

a direction determination section that determines a direction based on the stroke operation; and

a movement control section that controls movement of a given moving object displayed on a screen using the determined magnitude and the determined direction.

According to the above configuration, the touch start position indicator can be displayed on the touch panel, the magnitude of the operation input can be determined based on the moving path of the touch position within the touch start position indicator, and the direction can be input by the subsequent stroke operation.

Specifically, movement control of the moving object can be input by a simple operation that draws a moving path (e.g., small circle) at the touch position and then performs the stroke operation. Moreover, since the ball speed is not determined based on the speed of the stroke operation, the operation input can be implemented by a easy operation.

The method may further comprise:

determining a shape of the moving path; and

selecting a movement control pattern from a plurality of movement control patterns based on the determined shape, and controlling the movement of the moving object according to the selected movement control pattern.

According to the above configuration, since the movement control pattern of the moving object can be input merely by drawing the shape of the path after the touch operation, a more complicated input can be implemented by a simple operation. For example, when executing a baseball game, it is effective to set the pitch and the ball height as the movement control pattern.

The method may further comprise:

displaying a magnitude indicator based on the determined magnitude.

According to the above configuration, the player can determine the magnitude of the operation input performed on the touch panel by means of the magnitude indicator. Therefore, the player can easily master the stroke operation for obtaining the desired magnitude, and visually determine the magnitude input by the player.

The method may further comprise:

changing a moving direction of the moving object based on a magnitude of the stroke operation.

According to the above configuration, since the moving direction of the moving object can be changed merely by changing the magnitude of the stroke operation, operability can be further improved.

According to another embodiment of the invention, there is provided a computer-readable storage medium storing a program that causes a computer to execute one of the above methods. The term “storage medium” used herein includes a magnetic disk, an optical disk, an IC memory, and the like.

Embodiments of the invention are described below with reference to the drawings. Note that the following embodiments do not in any way limit the scope of the invention defined by the claims laid out herein. Note that all elements of the following embodiments should not necessarily be taken as essential requirements for the invention.

### First Embodiment

A first embodiment to which the invention is applied is described below taking an example of playing a baseball game using a portable game device provided with a touch panel.

Configuration of Game Device

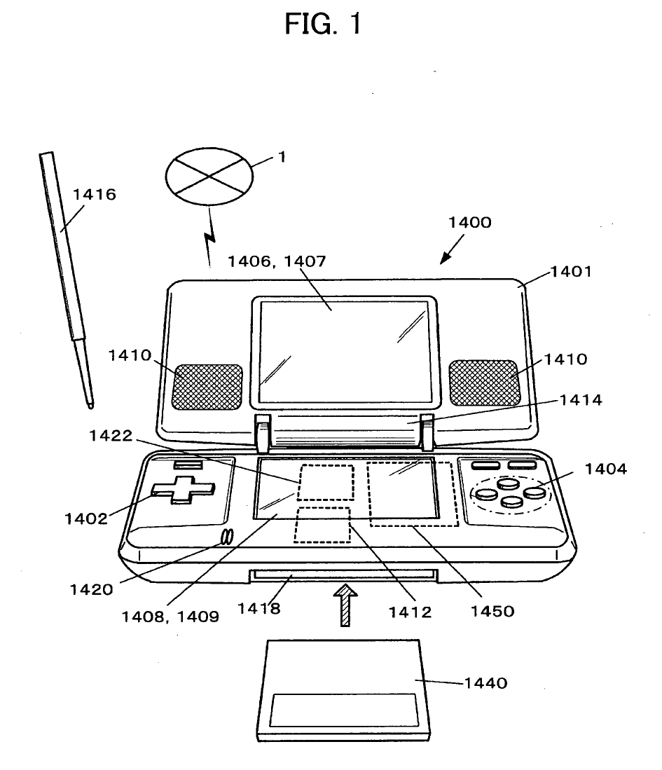

FIG. 1 is a view illustrative of a configuration example of a portable game device. A portable game device 1400 according to this embodiment includes an arrow key 1402 and a button switch 1404 that allow the player to input a game operation, a first liquid crystal display 1406, a second liquid crystal display 1408, a speaker 1410, a wireless communication module 1412, a control unit 1450, and a flip-top main body 1401 that can be opened and closed through a hinge 1414. Touch panels 1407 and 1409 that allow the player to perform an operation input by touching an arbitrary position within a display range using a stylus pen 1416 or the like are provided on the surfaces of the first liquid crystal display 1406 and the second liquid crystal display 1408, respectively.

The main body 1401 includes a reader 1418 that reads data from a memory card 1440 (i.e., computer-readable information storage medium). The memory card 1440 stores a program and setting data necessary for the control unit 1450 of the portable game device 1400 to execute various calculation processes. The main body 1401 is also provided with a built-in battery, a power button, a volume control button, and the like (not shown).

The control unit 1450 includes various microprocessors (e.g., central processing unit (CPU), graphics processing unit (GPU), and digital signal processor (DSP)), an application-specific integrated circuit (ASIC), an IC memory, a liquid crystal display driver circuit, a sound-output amplifier circuit, and the like.

The control unit 1450 executes various calculation processes based on the program and data stored in the memory card 1440 and read by the reader 1418. The control unit 1450 controls each section of the portable game device 1400 based on operation inputs performed using the arrow key 1402, the button switch 1404, and the touch panels 1407 and 1409.

The portable game device 1400 also includes a microphone 1420 and a triaxial acceleration sensor 1422.

The microphone 1420 collects sound or voice produced by the player during play, and outputs a signal of the collected sound to the control unit 1450. Note that the microphone 1420 is not limited to a microphone incorporated in the portable game device 1400. The portable game device 1400 may include a connection terminal to which an external microphone can be connected.

The triaxial acceleration sensor 1422 detects accelerations in an X-axis direction, a Y-axis direction, and a Z-axis direction that perpendicularly intersect to detect a change in posture or position of the portable game device 1400, and outputs detection signals to the control unit 1450. Note that the portable game device 1400 may include a gyrosensor instead of, or in addition to, the acceleration sensor. When detecting a change in position or posture of the portable game device 1400 based on terrestrial magnetism, the acceleration sensor may be replaced by a magnetic sensor.

In this embodiment, the portable game device 1400 reads a necessary program, setting data, and contents data from the memory card 1440. Note that the portable game device 1400 may connect to a communication line 1 (e.g., Internet, local area network (LAN), or wide area network (WAN)) through the wireless communication module 1412, and acquire a necessary program, setting data, and contents data from an external device via data communication.

Pitching Operation

A pitching operation input method according to this embodiment is described below.

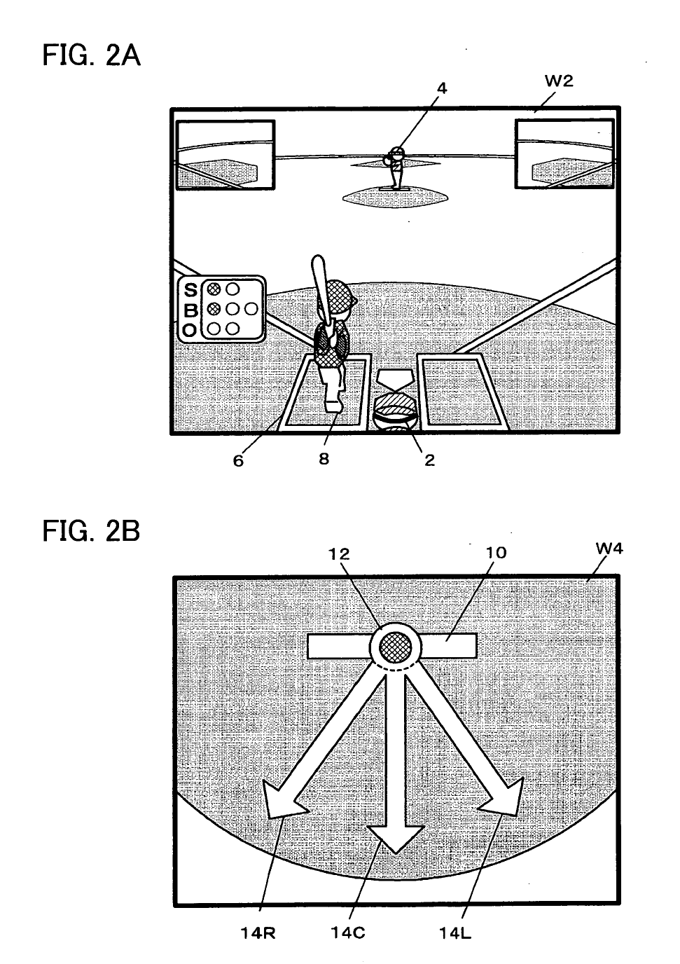

FIG. 2 is a view showing a game screen example according to this embodiment when the player's team plays defense. FIG. 2A shows a game screen W2 displayed on the first liquid crystal display 1406, and FIG. 2B shows a pitching operation input screen W4 displayed on the second liquid crystal display 1408.

The game screen W2 is displayed on the first liquid crystal display 1406 when the player inputs a pitching operation. The game screen W2 shows a field when viewing a pitcher 4 from above across a catcher 2. In FIG. 2A in which the player's team plays defense, the catcher 2 and the pitcher 4 are player characters of the player's team, and a batter 8 that stands within a batter's box 6 is a player character of an opposing team (non-player character (NPC; computer-controlled character) in this embodiment).

When the batter 8 has hit a ball, the game screen changes to a fielding screen in which the field is viewed from above at a wider viewing angle in the same manner as in a known baseball game.

The pitching operation input screen W4 displayed on the second liquid crystal display 1408 serves as a guide to a touch operation (i.e., pitching operation instruction input). The pitching operation input screen W4 is designed to imitate a pitcher's mound that is viewed from above so that a home plate is positioned in the downward direction with respect to the screen. A pitcher's plate 10 is drawn at a given position at the top of the screen. A pitching position mark 12 that indicates a pitching position is displayed over the pitcher's plate 10. The position of the pitching position mark 12 displayed over the pitcher's plate 10 corresponds to the position of the pitcher 4, and serves as a pitching start position indicator when the players inputs a pitching operation using the stylus pen 1416. Three pitching direction guides 14R, 14L, and 14C that extend from the pitching position mark 12 in a lower right direction, a lower left direction, and a right under direction are integrally displayed with the pitching position mark 12.

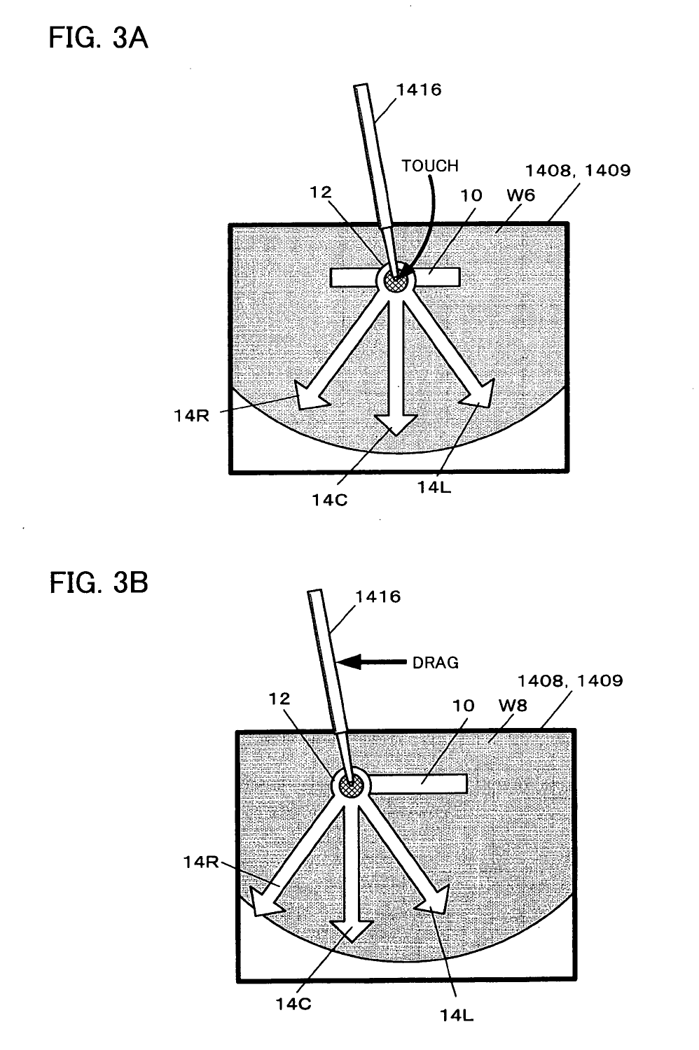

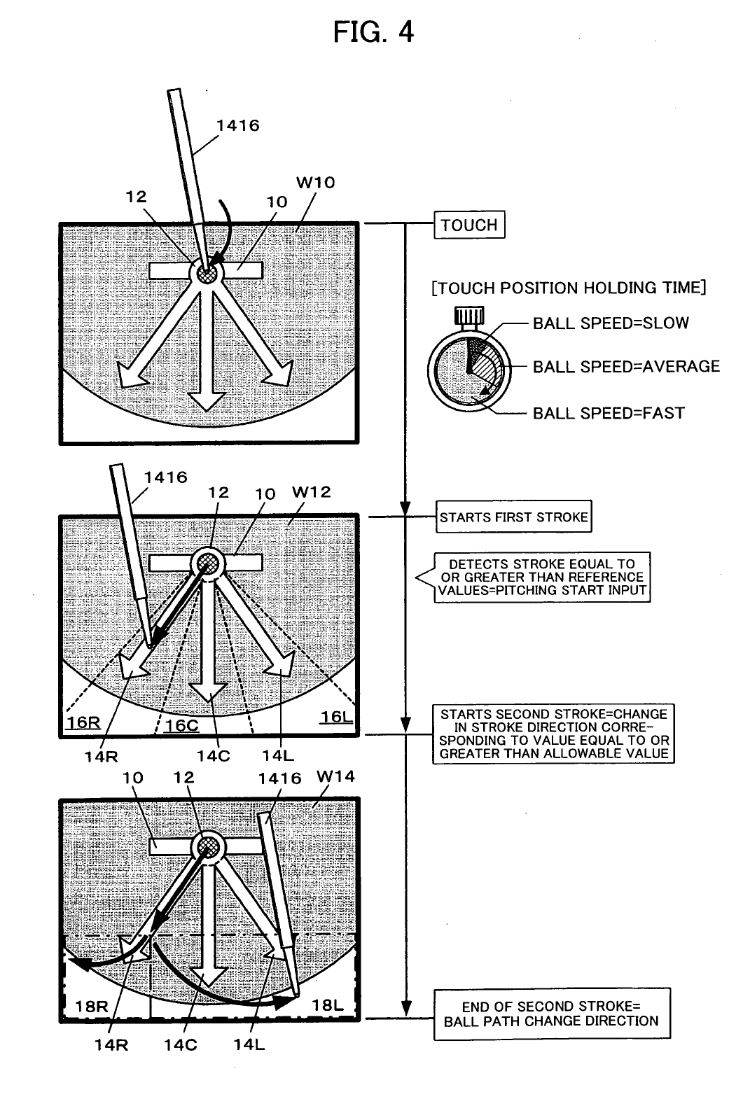

FIGS. 3 and 4 are views illustrative of a pitching operation input process according to this embodiment.

The player sets the pitching position as shown in FIG. 3. Specifically, the player brings the stylus pen 1416 into contact with the screen within the range of the pitching position mark 12 (FIG. 3A; pitching operation input screen W6), and slides the stylus pen 1416 sideways along the pitcher's plate 10 without removing the stylus pen 1416 from the pitching position mark 12 (drag operation). The pitching position mark 12 and the pitching direction guides 14R, 14C, and 14L follow the tip of the stylus pen 1416 (FIG. 3B; pitching operation input screen W8). When the player has dragged the stylus pen 1416 to the desired pitching position, the player removes the stylus pen 1416 from the pitching position mark 12 at the desired pitching position so that the pitching position of the pitcher 4 is changed (set) to the desired pitching position.

The player then successively performs a ball speed input operation, a pitching start input operation, a pitching direction input operation, and a ball direction change input operation using the stylus pen 1416, as shown in FIG. 4.

Specifically, the player performs the speed input operation by bringing the stylus pen 1416 into contact with the screen within the range of the pitching position mark 12 (W10), and holding the stylus pen 1416 at an identical position for a period of time corresponding to the desired ball speed. The player then performs a first stroke operation in the downward direction with respect to the screen at a speed equal to or higher than a given reference speed over a distance equal to or greater than a reference distance along the pitching direction guide 14R, 14C, or 14L corresponding to the desired pitching direction without removing the stylus pen 1416 from the screen. The pitching start input operation and the direction input operation are implemented by the first stroke operation (W12). The player then performs a second stroke operation in the direction in which the player desires to change the pitching direction to perform the ball direction change input operation (W14).

Specifically, regarding the ball speed input operation according to this embodiment, the ball speed is set in three stages corresponding to the touch (contact) position holding time from the first contact with the area of the pitching position mark 12 to the commencement of the first stroke operation (i.e., the ball speed is set to be low when the touch position holding time is shorter than a first reference time (e.g., shorter than one second), is set to be normal when the touch position holding time is equal to or longer than the first reference time and shorter than a second reference time (e.g., equal to or longer than one second and shorter than three seconds), and is set to be high when the touch position holding time is longer than the second reference time (e.g., equal to or longer than three seconds)). Note that the ball speed may be set in four or more stages or two or less stages, or may be set in proportion to the touch position holding time.

When a change in the touch position from the first touch position corresponds to a value less than a given distance, the touch position is considered to be maintained. It is preferable from the viewpoint of visibility that the given distance correspond to the diameter of a circle displayed at the center of the pitching position mark 12 shown in FIG. 4 in a display form differing from the pitching position mark 12.

Regarding the pitching start input operation according to this embodiment, the portable game device 1400 determines that the player has performed the pitching start input operation when a change in the touch position corresponds to movement in the downward direction with respect to the screen at a speed equal to or higher than a reference speed in a moving amount equal to or greater than a reference distance. This operation is the first stroke operation. Note that the reference speed may be appropriately set so that the player moves the stylus pen 1416 to imitate the movement of the arm of the pitcher. It is preferable that the reference distance approximately correspond to the diameter of the pitching position mark 12 from the viewpoint of visibility, for example.

Determination areas 16R, 16C, and 16L (approximately fan-shaped areas that are defined by broken lines and extend in three directions from the pitching position mark 12 in FIG. 4) respectively formed along the pitching direction guides 14R, 14C, and 14L are set in the downward direction from the center position of the pitching position mark 12. The portable game device 1400 determines that the player has performed the pitching direction input operation in the direction of the determination area that includes the touch position based on the determination area 16R, 16C, or 16L that includes the touch position when the portable game device 1400 has determined that the player has performed the pitching start input operation.

Regarding the ball direction change input operation according to this embodiment, the portable game device 1400 determines that the player has performed the second stroke operation when a sideways change in stroke direction corresponding to a value equal to or greater than an allowable value has been detected, and sets change direction determination areas 18R and 18L (areas enclosed by a dash-dotted line on the screen W14 shown in FIG. 4) on either side of the touch position at a position under the touch position when the portable game device 1400 has determined that the player has performed the second stroke operation. The ball path change direction is determined based on the change direction determination area 18R or 18L that includes the end position of the second stroke operation.

The portable game device 1400 determines that the player does not desire to change the pitching direction when only a change in stroke direction corresponding to a value less than the allowable value has been detected so that the pitching direction does not change. In this case, the pitcher throws a fastball.

Note that the determination areas 18R and 18L are not limited to the example shown in FIG. 4. The determination areas 18R and 18L may be simply set on either side of the center of the screen, or small rectangular areas may be set in the lower right area and the lower left area of the screen.

The pitching operation input method according to this embodiment enables the player to input the ball speed, the pitching start timing, the pitching direction, and the ball path change direction by performing a series of operations including bringing the stylus pen 1416 into contact with the touch panel 1409, holding the stylus pen 1416 in a stationary state for a given period of time, and moving the stylus pen 1416 without removing the stylus pen 1416 from the touch panel 1409. The series of operations is intuitive and smooth as if to forcefully swing the arm in the pitching direction and twist the wrist in the desired ball path change direction. Therefore, an operation input that is significantly intuitive and refreshing as compared with a pitching operation input method that operates the arrow key 1402 and the button switch 1404 is implemented. Moreover, since the player need not change the stroke speed in order to input the ball speed, a burden imposed on the player due to the operation input is significantly reduced even when the player repeats the pitching operation.

Batting Operation

A batting operation input method is described below.

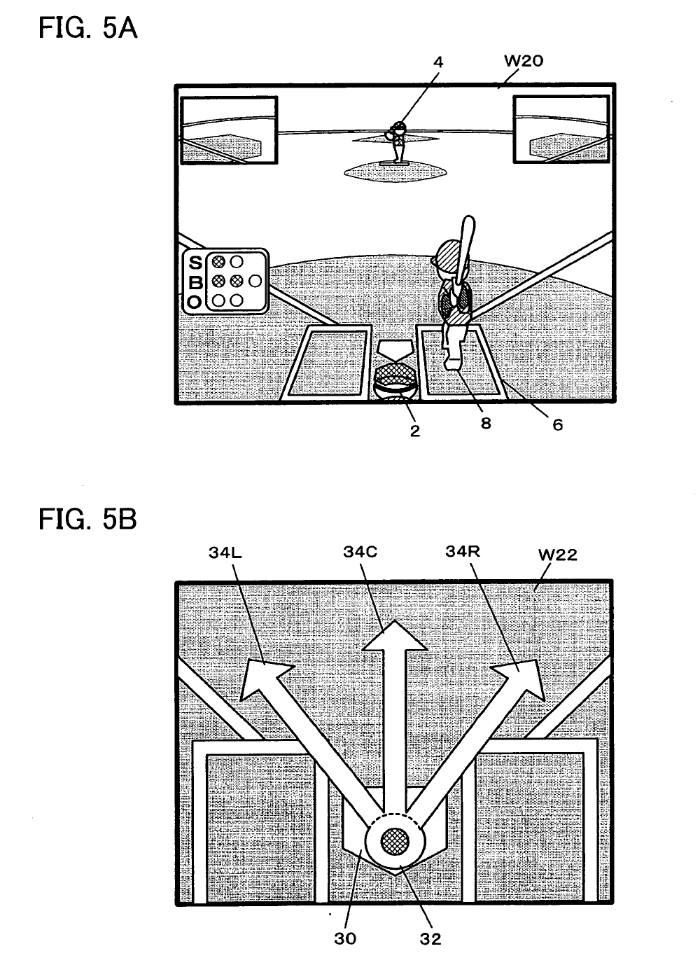

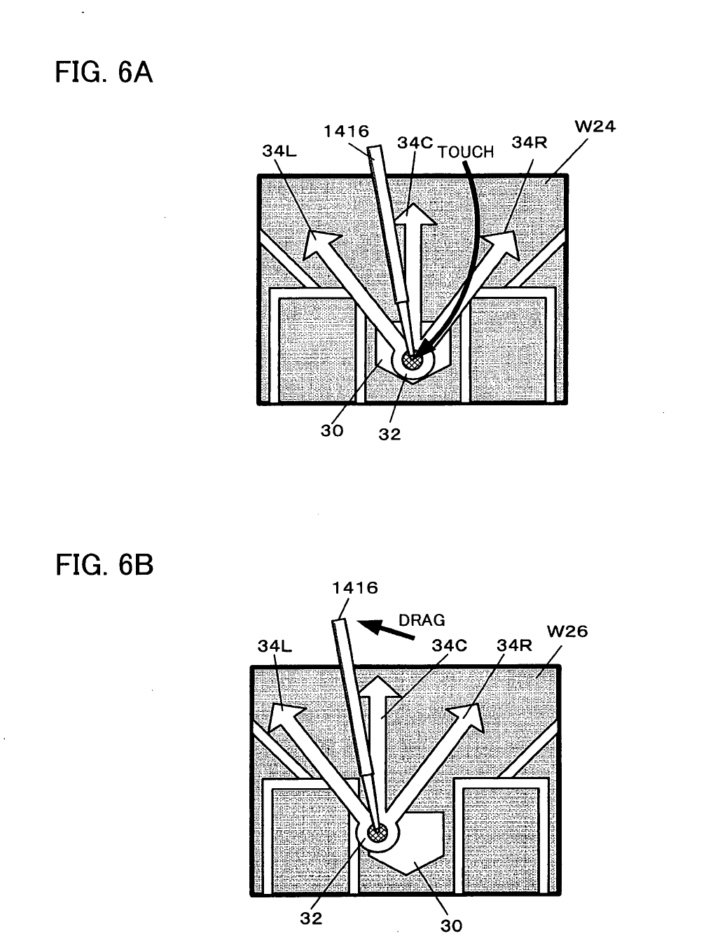

FIG. 5 is a view showing a game screen example according to this embodiment when the player's team plays offense. FIG. 5A shows a game screen W20 displayed on the first liquid crystal display 1406, and FIG. 5B shows a batting operation input screen W22 displayed on the second liquid crystal display 1408.

The game screen W20 basically has the same configuration as the game screen W2 displayed on the first liquid crystal display 1406 when the player inputs the pitching operation. However, since the player's team plays offense, the batter 8 is a player character of the player's team, and the catcher 2 and the pitcher 4 are player characters of the opposing team.

The batting operation input screen W22 is designed to imitate an area around the home plate that is viewed from above so that the center field is positioned in the upward direction with respect to the screen. The home plate 30 is displayed at the bottom of the screen. A batting position mark 32 is displayed over the home plate 30. The batting position mark 32 is a batting start position indicator that indicates the first touch position of the batting operation. Hitting direction guides 34R, 34C, and 34L that extend from the batting position mark 32 in an upper right direction, a right above direction, and an upper left direction are integrally displayed with the batting position mark 32.

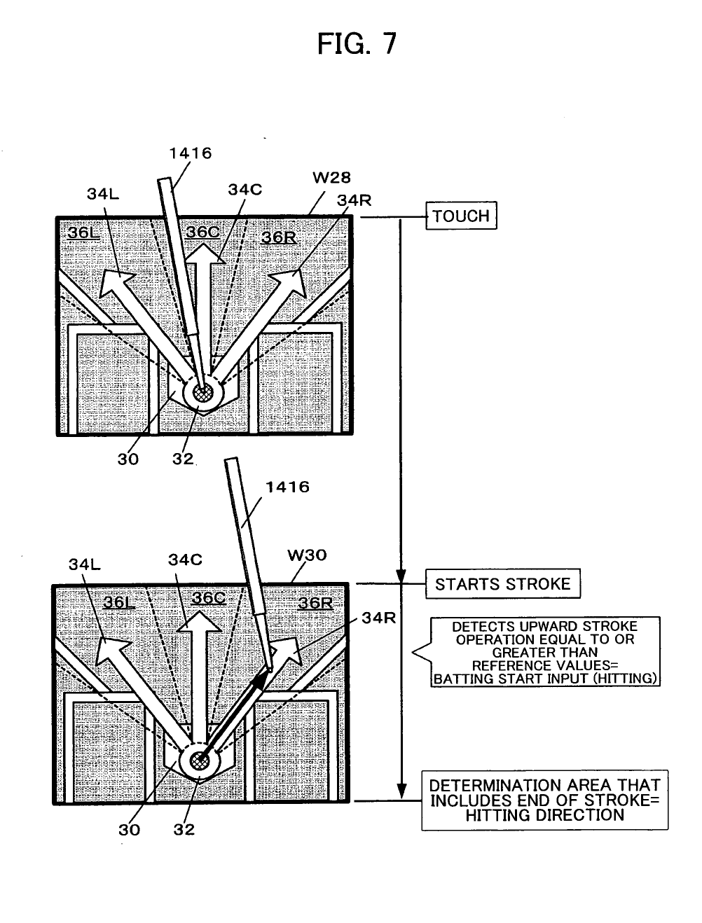

FIGS. 6 and 7 are views illustrative of a batting operation input process according to this embodiment.

When the player performs the batting operation according to this embodiment, the player inputs a batter's position (i.e., the position of the batter 8 within the batter's box 6) as indicated by a batting operation input screen W24 shown in FIG. 6A.

Specifically, the player brings the stylus pen 1416 into contact with the batting position mark 32 (FIG. 6A), and slides the stylus pen 1416 over the home plate 30 without removing the stylus pen 1416 from the batting position mark 32 (drag operation) so that the batting position mark 32 and the hitting direction guides 34R, 34C, and 34L are displayed at the position of the stylus pen 1416, as indicated by a batting operation input screen W26 shown in FIG. 6B. In the game screen W20, the position of the batter 8 within the batter's box 6 is changed.

Specifically, a rectangular area including the home plate 30 is defined corresponding to the batter's box 6. The dimension of the rectangular area in the vertical direction of the screen corresponds to the dimension of the batter's box 6 in the vertical direction of the screen, and the dimension of the rectangular area in the horizontal direction of the screen corresponds to the dimension of the batter's box 6 in the horizontal direction of the screen. When the player stops the stylus pen 1416 at the desired position, the position of the batter 8 within the batter's box 6 is changed and set corresponding to the position after movement.

When the player hits the ball, the player brings the stylus pen 1416 into contact with the batting position mark 32, and weighs the batting operation input timing, as indicated by a batting operation input screen W28 shown in FIG. 7. In this case, a game screen in which the pitcher 4 pitches the ball and the pitched ball (moving object) moves toward the catcher 2 is displayed on the first liquid crystal display 1406 (see FIG. 5) in the same manner as in a known baseball game.

The player slides the stylus pen 1416 along the hitting direction guide 34R, 34C, or 34L that indicates the desired hitting direction at an appropriate timing without removing the stylus pen 1416 from the screen (stroke operation) to perform a batting start input operation and a hitting direction input operation as a series of operations, as indicated by a batting operation input screen W30 shown in FIG. 7.

Specifically, the portable game device 1400 determines that the player has performed the batting start input operation when contact of the stylus pen 1416 with the batting position mark 32 has been detected and a stroke operation in the direction toward the top of the screen (i.e., a direction opposite to the moving direction of the pitched ball: forward direction) at a speed equal to or higher than a reference speed in an amount equal to or greater than a reference distance has been detected. When a change in position from the first touch position corresponds to a value less than a given distance, the touch position is considered to be maintained. It is preferable from the viewpoint of visibility that the given distance correspond to the diameter of a circle displayed at the center of the batting position mark 32 shown in FIG. 7 in a display form differing from the batting position mark 32. It is preferable that the reference distance approximately correspond to the diameter of the batting position mark 32 from the viewpoint of visibility, for example.

Determination areas 36R, 36C, and 36L (approximately fan-shaped areas that are defined by broken lines and extend upward in three directions from the batting position mark 32 in FIG. 7) respectively formed along the pitching direction guides 34R, 34C, and 34L are set from the center position of the batting position mark 32. The portable game device 1400 determines that the player has performed the hitting direction input operation in the direction of the determination area that includes the touch position based on the determination area 36R, 36C, or 36L that includes the touch position when the portable game device 1400 has determined that the player has performed the batting start input operation.

When the player has performed the batting start input operation and the hitting direction input operation, the portable game device 1400 determines whether or not the bat has hit the ball (ball hit determination) and determines the direction and the travel distance of the batted ball when the bat has hit the ball to proceed with the game.

For example, the portable game device 1400 may determine whether or not the bat has hit the ball by determining whether the player has made an infield hit, hit the ball outside the foul line, or missed the ball based on the difference between the time difference between the pitching start input operation and the batting start input operation and a reference time difference defined as the time difference from the time when the player gets good wood on the ball.

When the portable game device 1400 has determined that the player has made an infield hit, the portable game device 1400 may determine the direction and the travel distance of the batted ball the combination of the pitching position, the pitching direction, the batter's position, and the input timing of the batting start input operation.

In this embodiment, an infield batted ball is selected by lottery using one of the directions (right, center, and left) indicated by the ball direction guides 34R, 34C, and 34L as a basic direction. The direction input by the player's hitting direction input operation is selected with an appropriate weight so that the direction input by the player is selected with high probability. When the basic direction has been determined, the batted ball direction is determined by adding a random variation to the basic direction. In this embodiment, calculations are performed so that the moving direction of the batted ball (moving object) accurately coincides with the hitting direction as the batting start timing is closer to given contact timing.

The hit determination method, the ball direction determination method, and the ball travel distance determination method are not limited to the above-described methods. Other methods employed in a known baseball game may also be used.

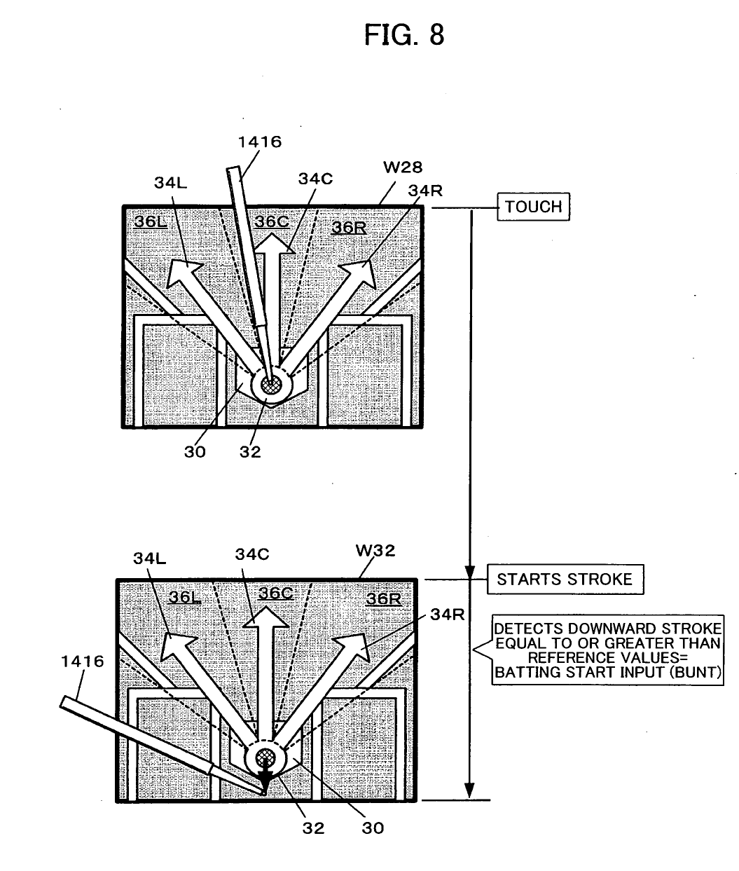

When the player bunts a ball, the player performs a stroke operation downward from the batting position mark 32 (direction along the moving direction of a pitched ball: reverse direction), as indicated by a batting operation input screen W32 shown in FIG. 8. When the portable game device 1400 has determined that the player has performed a stroke operation at a speed equal to or higher than a reference speed over a distance equal to or greater than a reference distance, the portable game device 1400 determines that the player has performed the batting start input operation by a bunt operation.

In this embodiment, the hitting direction is automatically and randomly determined when the player has performed a bunt operation.

Functional Blocks

A functional configuration that implements this embodiment is described below.

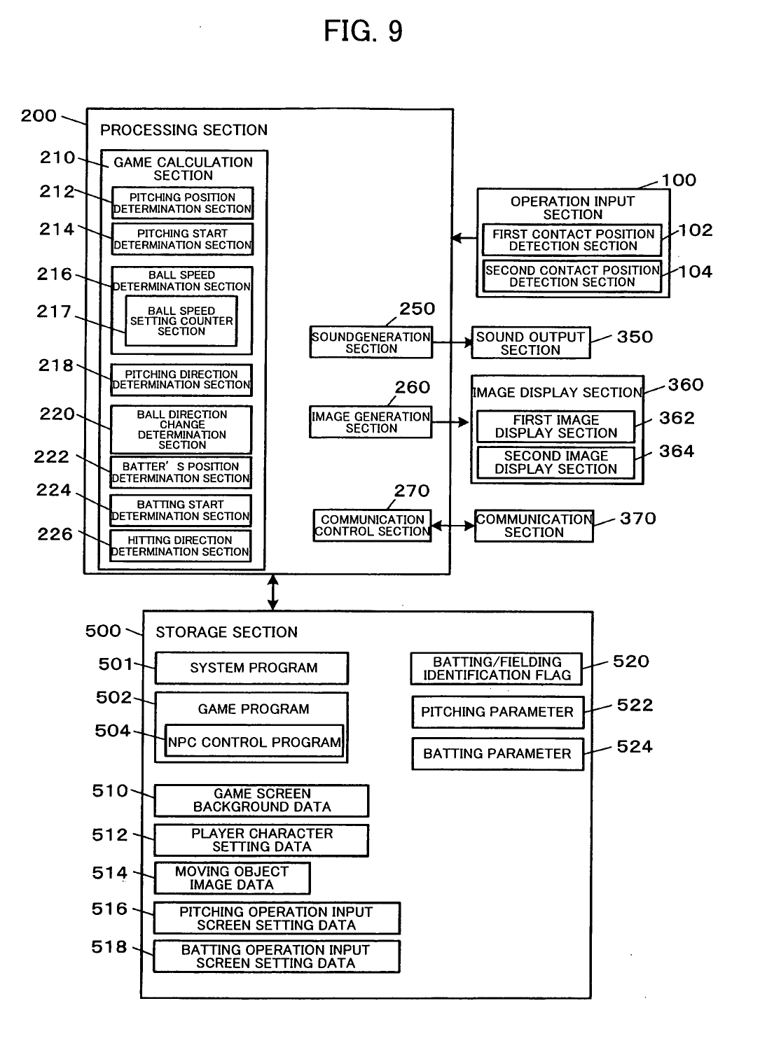

FIG. 9 is a functional block diagram showing an example of the functional configuration of the portable game device 1400 according to this embodiment. As shown in FIG. 9, the portable game device 1400 according to this embodiment includes an operation input section 100, a processing section 200, a sound output section 350, an image display section 360, a communication section 370, and a storage section 500. The image display section 360 includes a first image display section 362 and a second image display section 364.

The operation input section 100 is implemented by an input device and a sensor such as a push button, a lever, a touch panel, a dial, a keyboard, a mouse, a pointer, an acceleration sensor, or a tilt sensor. The operation input section 100 outputs an operation input signal to the processing section 200 corresponding to an operation input performed by the player. In this embodiment, the operation input section 100 includes a first contact position detection section 102 and a second contact position detection section 104 that detect the player's contact position.

In the example shown in FIG. 1, the arrow key 1402, the button switch 1404, and the touch panels 1407 and 1409 correspond to the operation input section 100. The touch panel 1407 corresponds to the first contact position detection section 102, and the touch panel 1409 corresponds to the second contact position detection section 104.

The processing section 200 is implemented by an electronic component such as a microprocessor, an application-specific integrated circuit (ASIC), and an IC memory. The processing section 200 exchanges data with each functional section, and controls the operation of the portable game device 1400 by performing various calculation processes based on a given program, data, and the operation input signal from the operation input section 100. In FIG. 1, the control unit 1450 corresponds to the processing section 200.

The processing section 200 according to this embodiment includes a game calculation section 210, a sound generation section 250, an image generation section 260, and a communication control section 270.

The game calculation section 210 performs a process relating to the progress of the baseball game. For example, the game calculation section 210 causes the players of the player's team and the computer-controlled opposing team to pitch, bat, defend, or run, controls the movement of the ball (moving object), determines the count and the number of outs, and counts the team score.

In this embodiment, the game calculation section 210 includes a pitching position determination section 212, a pitching start determination section 214, a ball speed determination section 216, a pitching direction determination section 218, and a ball direction change determination section 220 as functional sections relating to the pitching operation. The game calculation section 210 includes a batter's position determination section 222, a batting start determination section 224, and a hitting direction determination section 226 as functional sections relating to the batting operation.

The pitching position determination section 212 determines the position (pitching position) of the pitcher 4 with respect to the pitcher's plate 10 based on a touch operation performed in a given area that is set in the detection range of the second contact position detection section 104 and corresponds to the pitcher's plate 10 and the subsequent drag operation.

The pitching start determination section 214 determines the pitching start input timing based on detection of the contact position by the second contact position detection section 104. Specifically, when the player's team plays defense, the pitching start determination section 214 detects the first stroke operation in the downward direction at a speed equal to or higher than the reference speed over a distance equal to or greater than the reference distance based on a continuous change in the position of the touch operation on the touch panel 1409, and determines the detection timing to be the pitching start timing.

The ball speed determination section 216 determines the speed of the ball to be pitched based on detection of the contact position by the second contact position detection section 104. Specifically, the ball speed determination section 216 measures the touch position holding time within a period of time from the touch operation to determination of the start of the first stroke operation, and determines the pitching operation input value (i.e., ball speed) based on the measured time. More specifically, the ball speed determination section 216 includes a ball speed setting counter section 217. The ball speed setting counter section 217 measures the time elapsed after the player has brought the stylus pen into contact with the pitching position mark 12 when performing the pitching operation until the stroke operation that satisfies the pitching start condition is detected (i.e., the pitching start determination section 214 determines that the player has started the pitching operation).

The pitching direction determination section 218 determines the direction of the ball to be pitched based on detection of the contact position by the second contact position detection section 104. Specifically, the pitching direction determination section 218 determines the determination area 16R, 16C, or 16L that is set in the detection range of the second contact position detection section 104 and corresponds to the touch position when the pitching start determination section 214 has detected a stroke operation at a speed equal to or higher than the reference speed over a distance equal to or greater than the reference distance.

The ball direction change determination section 220 determines the change direction of the moving path of a pitched ball based on detection of the contact position by the second contact position detection section 104. Specifically, the ball direction change determination section 220 determines that the second stroke has been input when a change in stroke direction sideways from the moving direction of the first stroke in an amount equal to or larger than a reference value has been detected. The ball direction change determination section 220 sets the determination areas 18R and 18L in the detection area of the second contact position detection section 104 below the touch position when the ball direction change determination section 220 has determined that the second stroke has been input, the determination areas 18R and 18L being positioned on either side of the touch position, and determines a second direction input by determining the determination area 18R or 18L that includes the end position of the second stroke. In this embodiment, the second direction input is determined to be the change direction of the moving path of a pitched ball.

The batter's position determination section 222 determines the position of the batter 8 within the batter's box 6 based on detection of the contact position by the second contact position detection section 104. Specifically, the batter's position determination section 222 changes the position of the batter 8 based on the drag operation of the batting position mark 32.

The batting start determination section 224 determines the batting start input timing based on detection of the contact position by the second contact position detection section 104. Specifically, when the player's team plays defense, the batting start determination section 224 detects a stroke operation in the upward direction at a speed equal to or higher than the reference speed over a distance equal to or greater than the reference distance based on a continuous change in the position of the touch operation on the touch panel 1409, and determines the detection timing to be the batting start timing.

The hitting direction determination section 226 determines the hitting direction based on detection of the contact position by the second contact position detection section 104. Specifically, the hitting direction determination section 226 sets the determination areas 36R, 36C, and 36L that extend upward in different directions based on the position coordinates of the batting position mark 32 when the batting start determination section 224 has detected a stroke operation at a speed equal to or higher than the reference speed over a distance equal to or greater than the reference distance, and determines the hitting direction by determining the determination area 36R, 36C, or 36L that includes the touch position at the batting start timing.

The sound generation section 250 is implemented by a sound generation LSI, a processor such as a digital signal processor (DSP), its control program, and the like. The sound generation section 250 generates a sound signal of game sound such as effect sound, background music (BGM), or operation sound based on the processing results of the game calculation section 210, and outputs the generated sound signal to the sound output section 350.

The sound output section 350 is implemented by a device that outputs sound such as effect sound or BGM based on the sound signal output from the sound generation section 250. The speaker 1410 shown in FIG. 1 corresponds to the sound output section 350.

The image generation section 260 is implemented by an LSI such as a graphics processing unit (GPU) or a digital signal processor (DSP), its control program, a drawing frame IC memory such as a frame buffer, and the like. The image generation section 260 generates an image (game screen) based on the processing results of the game calculation section 210. The image generation section 260 generates the game image, the pitching operation input screen, or the batting operation input screen shown in FIGS. 2 to 8 in frame time ( 1/60 sec) units, and outputs an image signal of the generated image to the image display section 360.

The image display section 360 displays various game screens based on the image signal output from the image generation section 260. The image display section 360 may be implemented by an image display device such as a flat panel display, a cathode-ray tube (CRT), a projector, or a head mount display. The image display section 360 according to this embodiment includes the first image display section 362 and the second image display section 364. The first image display section 362 corresponds to the first liquid crystal display 1406 shown in FIG. 1, and the second image display section 364 corresponds to the second liquid crystal display 1408.

The communication control section 270 performs data processing relating to data communication, and exchanges data with an external device via the communication section 370.

The communication section 370 connects to a communication line to implement communication. The communication section 370 is implemented by a transceiver, a modem, a terminal adapter (TA), a jack for a communication cable, a control circuit, and the like. In FIG. 1, the wireless communication module 1412 corresponds to the communication section 370.

The storage section 500 stores a program and data defined in advance, and serves as a work area for the processing section 200. The storage section 500 temporarily stores the results of calculations performed by the processing section 200 according to various programs, data input from the operation input section 100, and the like. The function of the storage section 500 is implemented by an IC memory (e.g., RAM or ROM), a magnetic disk (e.g., hard disk), an optical disk (e.g., CD-ROM or DVD), or the like.

The storage section 500 according to this embodiment stores a system program 501 that implements a function for causing the processing section 200 to control the portable game device 1400, a game program 502 necessary for causing the processing section 200 to execute the game, various types of data, and the like. The function of the game calculation section 210 may be implemented by the processing section 200 by causing the processing section 200 to read and execute the game program 502. The game program 502 includes an NPC control program 504 used to automatically control the movement of the non-player character (NPC) that is the player character of the opposing team.

The storage section 500 also stores game screen background data 510, player character setting data 512, moving object image data 514, pitching operation input screen setting data 516, and batting operation input screen setting data 518 as data provided in advance.

In this embodiment, the game screen and the defense screen are generated by synthesizing two-dimensional bitmap images. The player character and the ball (moving object) are moved by selectively displaying given bitmap images.

Background image data of the game screen W2, the defense screen, and the like is stored as the game screen background data 510 according to this embodiment. A display image of each player character of the player's team and the opposing team during pitching, fielding, and batting and initial setting data (e.g., various capability parameters of each player), are stored as the player character setting data 512. An image that indicates the travel state of a pitched ball and an image that indicates the travel state of a batted ball are stored as the moving object image data 514.

When generating the game screen and the like by three-dimensional computer graphics, three-dimensional model data and texture data relating to a stadium and a field are stored as the game screen background data 510, and three-dimensional model data, texture data, and motion data relating to each character are stored as the player character setting data 512. Three-dimensional model data and the like relating to the ball are stored as the moving object image data 514.

A background image in which the pitcher's plate 10 and the like are drawn and images of the pitching position mark 12 and the pitching direction guides 14R, 14C, and 14L used when displaying the pitching operation input screen W4 are stored as the pitching operation input screen setting data 516.

A background image in which the home plate 30 and the batter's box are drawn and images of the batting position mark 32 and the hitting direction guides 34R, 34C, and 34L used when displaying the batting operation input screen W22 are stored as the batting operation input screen setting data 518.

The storage section 500 also stores a batting/fielding identification flag 520, pitching parameters 522, and batting parameters 524 as data stored with the progress of the game.

“1” is stored as the batting/fielding identification flag 520 when the player's team plays offense, and “0” is stored as the batting/fielding identification flag 520 when the player's team plays defense.

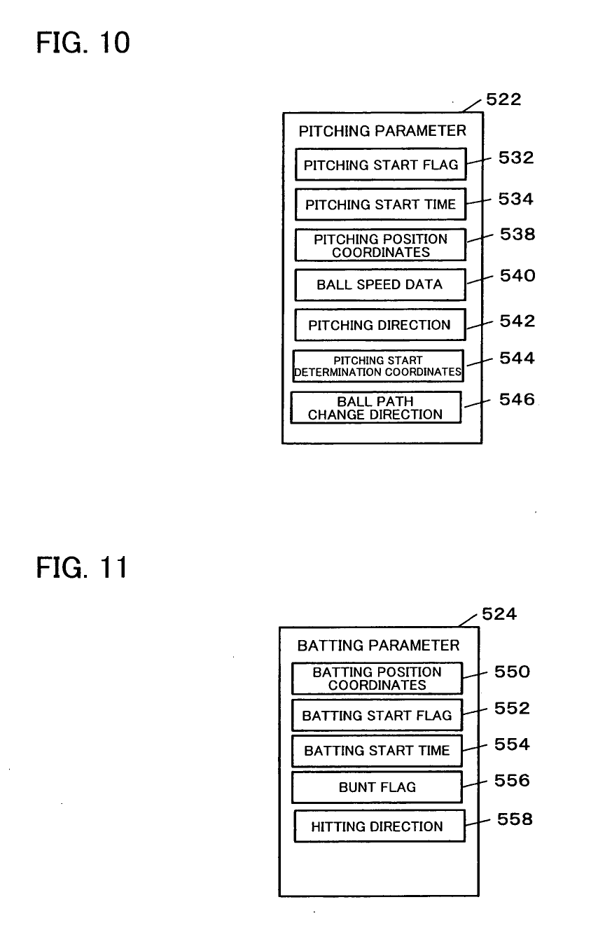

As shown in FIG. 10, the pitching parameters 522 include a pitching start flag 532, a pitching start time 534, pitching position coordinates 538, ball speed data 540, a pitching direction 542, pitching start determination coordinates 544, and a ball path change direction 546, for example.

Specifically, “1” is stored as the pitching start flag 532 when the player has performed the pitching operation and has been determined to have started pitching, or when the pitcher 4 of the opposing team has started pitching by automatic control when the player performs the batting operation.

A system time when the player has performed the pitching operation and has been determined to have started pitching is stored as the pitching start time 534. The pitching start time 534 is used for ball-bat hit determination and the like by comparing the pitching start time 534 with the system time when the batter has been determined to have started batting.

The coordinate values of the detection coordinates of the second image display section 364 that indicate the position of the pitcher 4 on the pitcher's plate 10 are stored as the pitching position coordinates 538.

Information that indicates the speed (i.e., slow, average, or fast) of a pitched ball is stored as the ball speed data 540.

Information that indicates the pitching direction is stored as the pitching direction 542.

The coordinates of the touch position when the player has been determined to have started pitching are stored as the pitching start determination coordinates 544.

Information that indicates the change direction of the moving path of a pitched ball is stored as the ball path change direction 546.

As shown in FIG. 11, the batting parameters 524 include batting position coordinates 550, a batting start flag 552, a batting start time 554, a bunt flag 556, and a hitting direction 558, for example.

Specifically, the coordinates of the position of the batter 8 within the batter's box 6 are stored as the batting position coordinates 550. The coordinates of the center of the batter's box 6 are initially stored as the batting position coordinates 550.

“0” is initially stored as the batting start flag 552. “1” is stored as the batting start flag 552 when the player has been determined to have input a batting start operation (i.e., swung the bat).

The system time when the player has been determined to have input a batting start operation is stored as the batting start time 554.

“0” is initially stored as the bunt flag 556. When “0” is stored as the bunt flag 556, the player does not bunt a ball (i.e., hitting). “1” is stored as the bunt flag 556 when the player has input a given bunt operation.

The storage section 500 may further appropriately store various types of data necessary for the game process in the same manner as in a known baseball game.

Process Flow

The process flow according to this embodiment is described below. A series of processes described below is implemented by causing the processing section 200 to read the system program 501 and the game program 502 from the storage section 500 and execute these programs. The series of processes is repeated in a cycle sufficiently shorter than the refresh rate of the image display section 360.

A process that allows the player to select a team, a process that allows the player to select the opposing team, a process that determines the team that takes to the field first, and the like are appropriately executed before the following processes in the same manner as in a known baseball game. The following description focuses on the processes after the game has started.

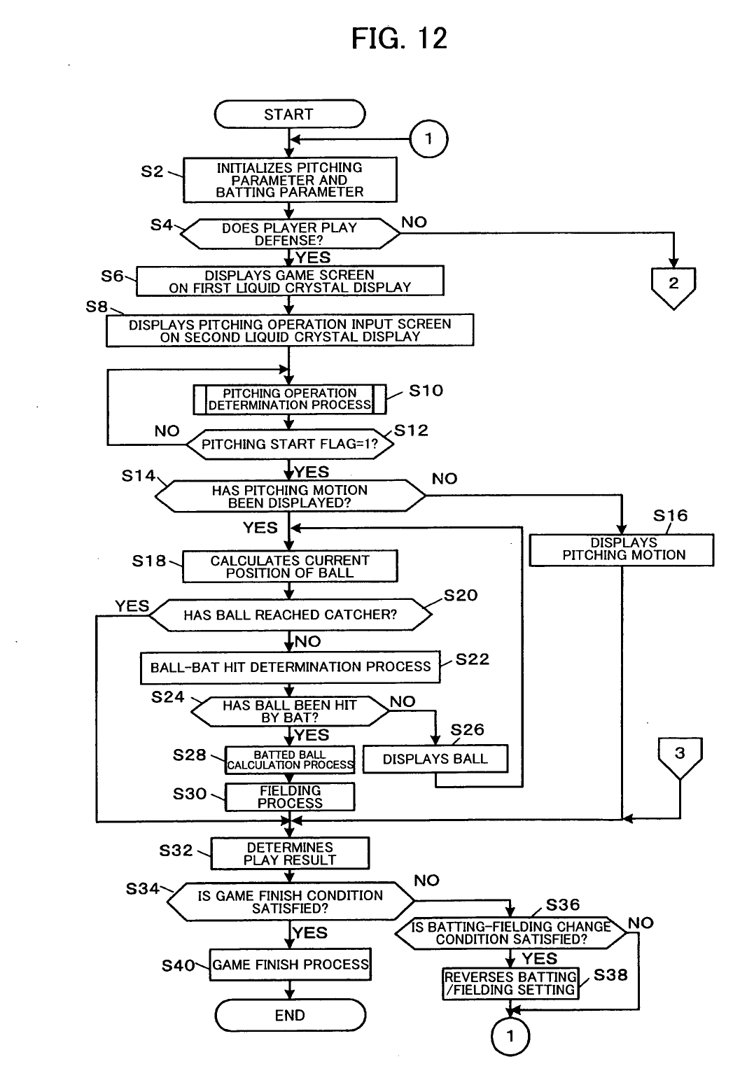

FIG. 12 is a flowchart illustrative of the flow of the main processes according to this embodiment. The processing section 200 initializes the pitching parameters 522 and the batting parameters 524 (step S2). Specifically, the processing section 200 stores “0” (non-input state) as the pitching start flag 532 included in the pitching parameter 522. The processing section 200 resets the pitching start time 534, and stores given coordinate values that correspond to the center position of the pitcher's plate 10 in the longitudinal direction as the pitching position coordinates 538. The processing section 200 sets “average” as the ball speed data 540, and sets “front” as the pitching direction 542. The processing section 200 stores given coordinate values that correspond to the center position of the pitcher's plate 10 in the longitudinal direction as the pitching start determination coordinates 544, and sets “front” as the ball path change direction 546 to initialize the ball path change direction 546 (i.e., the path of a pitched ball is not changed).

The processing section 200 stores the coordinates of the center position of the batter's box 6 as the batting position coordinates 550 included in the batting parameters 524, and sets “0” as the batting start flag 552. The processing section 200 resets the batting start time 554, and stores “0” as the bunt flag 556. The processing section 200 sets “front” as the hitting direction 558 to initialize the hitting direction 558.

The processing section 200 refers to the batting/fielding identification flag 520. When the player's team plays defense (YES in step S4), the processing section 200 causes the first liquid crystal display 1406 to display a game screen in which the player's team plays defense and the opposing team plays offense (see the screen W2 shown in FIG. 2A) (step S6), causes the second liquid crystal display 1408 to display a pitching operation input screen (see the screen W4 shown in FIG. 2B) (step S8), and executes a pitching operation determination process (step S10).

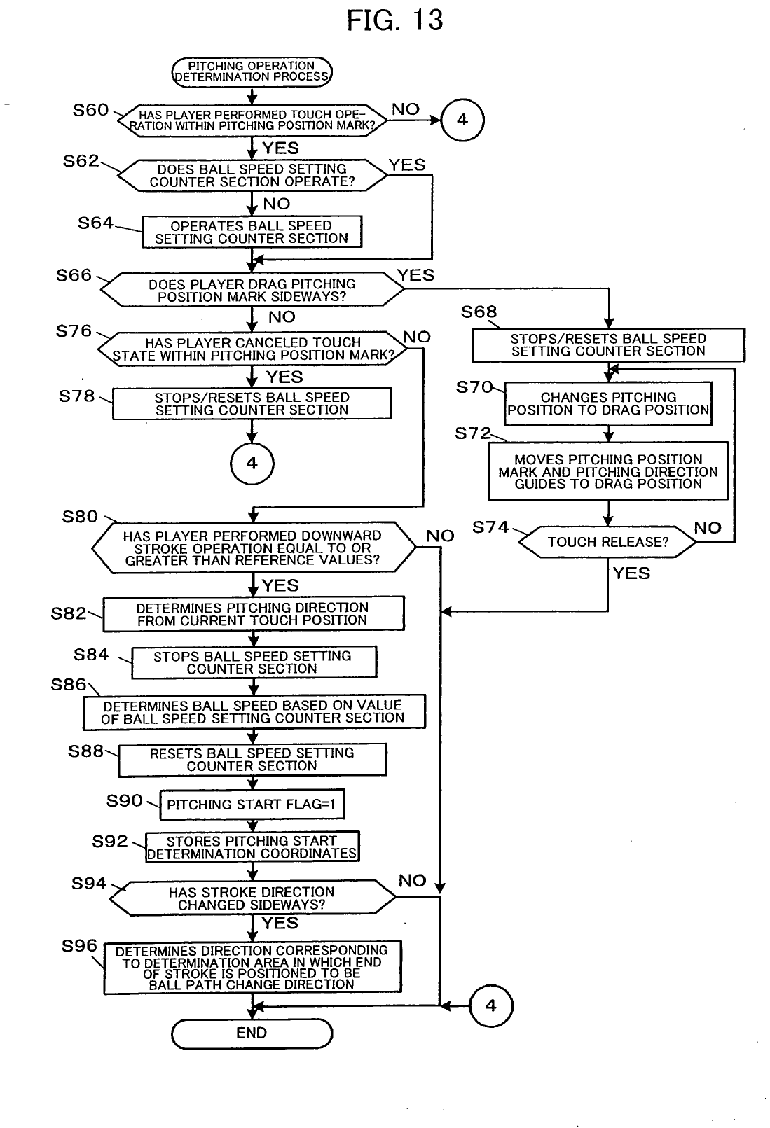

FIG. 13 is a flowchart illustrative of the flow of the pitching operation determination process according to this embodiment. The processing section 200 determines whether or not the player has performed a touch operation within the pitching position mark 12 (step S60). When the processing section 200 has determined that the player has not performed a touch operation within the pitching position mark 12 (NO in step S60), the processing section 200 finishes the pitching operation determination process, and returns to the flowchart shown in FIG. 12.

When the processing section 200 has determined that the player has performed a touch operation within the pitching position mark 12 (YES in step S60), the processing section 200 causes the ball speed setting counter section 217 to start a counter operation that measures the time elapsed after the touch operation has been detected (step S64) in case the ball speed setting counter section 217 has not operated (NO in step S62).

The processing section 200 determines whether or not the player drags the pitching position mark 12 sideways (step S66). When the player has performed a slide operation along the pitcher's plate 10 while maintaining the touch state, the processing section 200 determines that the player has performed the drag operation (YES in step S66), and stops and resets the ball speed setting counter section 217 (step S68). The processing section 200 stores the coordinates of the current touch position as the pitching position coordinates 538 (one of the pitching parameters) (step S70), and moves the pitching position mark 12 and the pitching direction guides 14R, 14C, and 14L to the drag position (step S72). The movable range of the pitching position corresponds to the range of the pitcher's plate 10.

The processing section 200 repeats the process in the steps S70 and S72 until the player cancels the touch state and stops the drag operation (NO in step S74) so that the player can easily and intuitively set the desired pitching position by the touch operation using the stylus pen 1416. When the player has stopped the drag operation (YES in step S74), the processing section 200 finishes the pitching operation determination process.

When the processing section 200 has determined that the player has performed a touch operation within the pitching position mark 12 without performing a drag operation in the step S66 (NO in step S66) and has canceled the touch state within the pitching position mark 12, the processing section 200 determines that the player has stopped the pitching start input operation, stops and resets the ball speed setting counter section 217 (step S78), and finishes the pitching operation determination process.

When the processing section 200 has determined that the player has performed a touch operation within the pitching position mark 12 in the step S66 and determined that the player has not canceled the touch state (NO in step S76), the processing section 200 determines whether or not the player has performed a stroke operation in the downward direction with respect to the pitching position mark 12 at a speed equal to or higher than the reference speed over a distance equal to or greater than the reference distance (step S80). The speed and the distance of the stroke operation may be determined using a known touch panel input technology.

When the processing section 200 has detected that the player has performed a stroke operation at a speed equal to or higher than the reference speed over a distance equal to or greater than the reference distance (YES in step S80), the processing section 200 determines the determination area 16R, 16C, or 16L that is set along the pitching direction guide 14R, 14C, or 14L and includes the coordinates of the touch position when the processing section 200 has detected that the player has performed the stroke operation (origin: the coordinates of the pitching position mark 12), determines the direction of the determination area that includes the coordinates of the touch position to be the pitching direction, and stores direction instruction information that indicates the pitching direction in the storage section 500 as the pitching direction 542 (step S82).

The processing section 200 causes the ball speed setting counter section 217 to stop measurement (step S84), determines the ball speed based on the counter value of the ball speed setting counter section 217, and stores ball speed identification information in the storage section 500 as the ball speed data 540 (step S86).

The processing section 200 resets the ball speed setting counter section 217 (step S88), stores “1” as the pitching start flag 532 (step S90), and stores the coordinate values of the touch position as the pitching start determination coordinates 544 (step S92). Specifically, the processing section 200 has determined that the player has performed the pitching start operation input by the touch operation within the pitching position mark 12 and the stroke operation along the pitching direction guide 14R, 14C, or 14L.

The processing section 200 determines whether or not the direction of the stroke operation has changed sideways in an amount equal to or larger than a reference value (step S94). When the processing section 200 has detected a change in the direction of the stroke operation in an amount equal to or larger than the reference value (YES in step S94), the processing section 200 determines that the player has input the second stroke operation, and sets the determination areas 18R and 18L at the bottom of the screen (origin: pitching start determination coordinates 544). The processing section 200 determines the direction corresponding to the determination area in which the end of the stroke is positioned to be the ball path change direction, stores information that indicates the determined direction in the storage section 500 as the ball path change direction 546 (step S96), and finishes the pitching operation determination process.

When the processing section 200 has not detected a change in the direction of the stroke operation in an amount equal to or larger than the reference value in the step S94, the processing section 200 finishes the pitching operation determination process in a state in which the ball path change direction 546 is initialized. In this case, the pitcher pitches a fastball that substantially does not change in moving path.

According to this embodiment, the player can input the ball speed, the pitching start instruction, and the pitching direction by one stroke as if to pitch a ball using the tip of the stylus pen 1416 by bringing the stylus pen 1416 into contact with the pitching position mark 12, maintaining the touch position by the image as if to accumulate the pitching force, and performing the first stroke operation downward along the pitching direction guide 14R, 14C, or 14L that corresponds to the desired pitching direction.

The player can input the change direction of the moving path of a pitched ball (i.e., can pitch a breaking ball) by performing the second stroke operation sideways after the first stroke operation.

Again referring to FIG. 12, when the processing section 200 has finished the pitching operation determination process, the processing section 200 refers to the pitching start flag 532. When the pitching start flag 532 is “0” (NO in step S12), since the player has not performed a pitching instruction input, the processing section 200 again executes the pitching operation determination process. When the pitching start flag 532 is “1” (YES in step S12), the processing section 200 determines whether or not the pitching motion of the pitcher 4 has been displayed (step S14). When the pitching motion of the pitcher 4 has not been displayed (NO in step S14), the processing section 200 causes the pitching motion of the pitcher 4 to be displayed (step S16).

When the pitching motion of the pitcher 4 has been displayed (YES in step S14), the processing section 200 calculates the current position of the pitched ball (step S18). The processing section 200 calculates the current position of the pitched ball referring to the pitching parameters 522.

When the processing section 200 has determined that the ball has not reached the catcher 2 as a result of calculations (NO in step S20), the processing section 200 executes a ball-bat hit determination process (i.e., whether or not the pitched ball has been hit by the batter 8 of the opposing team) (step S22) in the same manner as in a known baseball game. When the processing section 200 has determined that the pitched ball has not been hit by the bat (NO in step S24), the processing section 200 displays the ball at the calculated position (step S26).

When the processing section 200 has determined that the ball has not reached the catcher 2 and hit by the bat (YES in step S24), the processing section 200 executes a batted ball calculation process to calculate the direction and the travel distance of the batted ball (step S28) in the same manner as in a known baseball game. The processing section 200 then executes a fielding process (step S30), and executes a play result determination process (step S32). In the play result determination process, the processing section 200 determines a strike, a ball, a catch, the number of outs, and the like in the same manner as in a known baseball game.

The processing section 200 determines whether or not the play result satisfies a given game finish condition (step S34). When the processing section 200 has determined that the play result does not satisfy the game finish condition (NO in step S34), the processing section 200 determines whether or not a batting-fielding change condition is satisfied (step S36). When the processing section 200 has determined that the batting-fielding change condition is not satisfied (NO in step S36), the processing section 200 returns to the step S2. When the processing section 200 has determined that the batting-fielding change condition is satisfied (YES in step S36), the processing section 200 reverses the setting of the batting/fielding identification flag 520 (step S38), and returns to the step S2.

When the processing section 200 has determined that the game finish condition is satisfied (YES in step S34), the processing section 200 performs a given game finish process such as displaying an ending image (step S40), and finishes the series of game processes.

The process flow when the player's team plays offense is described below.

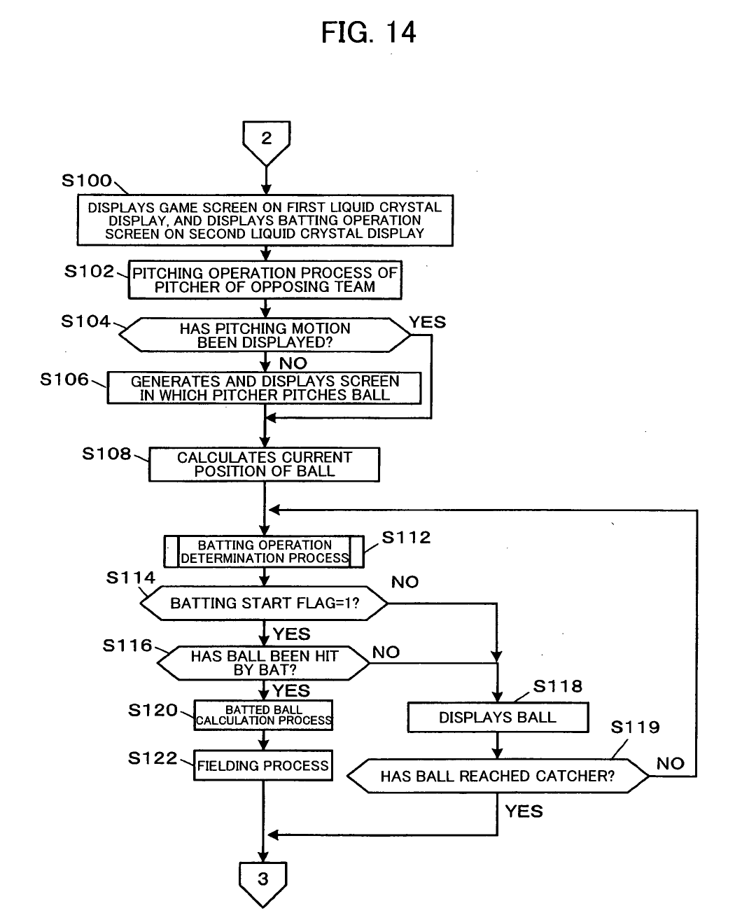

The processing section 200 refers to the batting/fielding identification flag 520 in the step S4. When the player's team plays offense (NO in step S4), the processing section 200 transitions to a flowchart shown in FIG. 14. The processing section 200 causes the first liquid crystal display 1406 to display a game screen in which the player's team plays offense and the opposing team plays defense (see the screen W20 shown in FIG. 5A), and causes the second liquid crystal display 1408 to display the batting operation input screen W22 (step S100).

The processing section 200 executes a pitching start process of the pitcher of the opposing team, and automatically determines the ball speed, the pitching start timing, the pitching direction, and the ball path change direction (step S102).

When the pitching motion of the pitcher of the opposing team has not been displayed (NO in step S104), the processing section 200 causes the pitching motion of the pitcher of the opposing team to be displayed on the game screen (step S106).

The processing section 200 then calculates the current position (moving path) of the pitched ball (step S108) in the same manner as in a known baseball game. The processing section 200 then executes a batting operation determination process in order to detect the batting operation of the player (step S112).

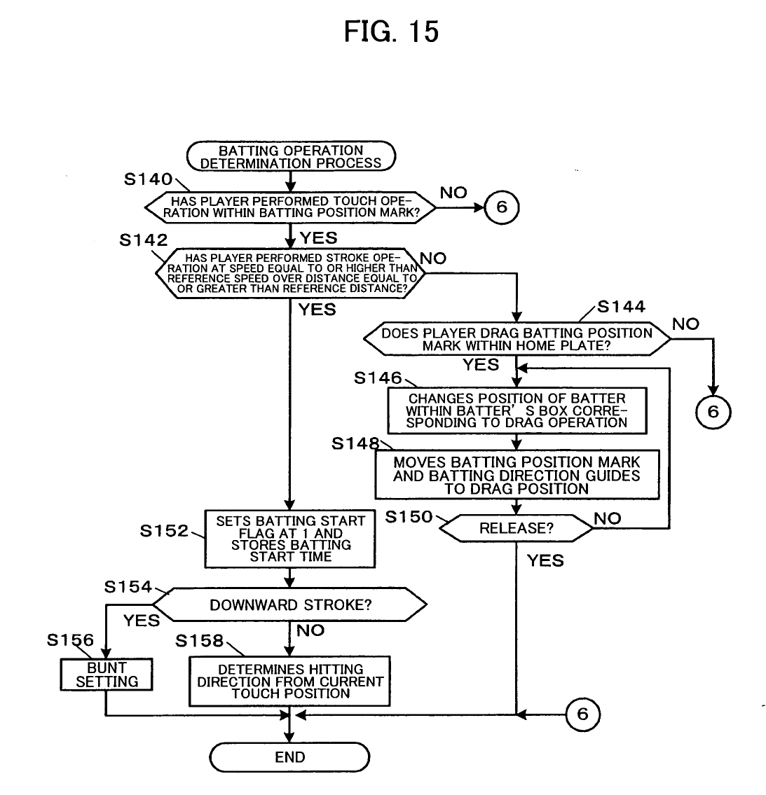

FIG. 15 is a flowchart illustrative of the flow of the batting operation determination process according to this embodiment. In the batting operation determination process according to this embodiment, the processing section 200 determines whether or not the player has performed a touch operation within the batting position mark 32. When the processing section 200 has determined that the player has performed a touch operation within the batting position mark 32 (YES in step S140), the processing section 200 determines whether or not the player has performed a stroke operation at a speed equal to or higher than the reference speed over a distance equal to or greater than the reference distance (step S142).

When the speed of the stroke operation is lower than the reference speed or the moving distance of the stroke operation is shorter than the reference distance (NO in step S142), the processing section 200 determines whether or not the player drags the batting position mark 32 within the home plate 30 (step S144).

When the processing section 200 has determined that the player drags the batting position mark 32 within the home plate 30 (YES in step S144), the processing section 200 changes the coordinates stored in the storage section 500 as the batting position coordinates 550 corresponding to the drag operation to change the position of the batter 8 within the batter's box 6 (step S146), and moves the batting position mark 32 and the hitting direction guides 34R, 34C, and 34L to the drag position (step S148).

The processing section 200 repeats the process in the steps S146 and S148 until the player has canceled the touch state and stopped the drag operation. When the player has stopped the drag operation (YES in step S150), the processing section 200 finishes the batting operation determination process.

When the processing section 200 has determined that the player has performed a touch operation within the batting position mark 32 and performed a stroke operation at a speed equal to or higher than the reference speed over a distance equal to or greater than the reference distance (YES in step S142), the processing section 200 determines that the player has input a batting start operation (i.e., the bat has been swung), stores “1” as the batting start flag 552, and stores the system time when the player has input the batting start operation as the batting start time 554 (step S152).

When the moving direction of the stroke operation at a speed equal to or higher than the reference speed over a distance equal to or greater than the reference distance is a direction along the movement display direction of the moving object (reverse direction) (i.e., lower than the batting position mark 32 (YES in step S154), the processing section 200 determines that the player has bunted the ball, stores “1” as the bunt flag 556 (step S156), and finishes the batting operation determination process.

When the moving direction of the stroke operation is a direction upward from the batting position mark 32 (forward direction) (NO in step S154), the processing section 200 determines that the player has hit the ball, stores “0” as the bunt flag 556, sets the determination areas 36R, 36C, and 36L (see FIG. 7) at the top of the screen with respect to the batting position mark 32, stores identification information relating to the determined hitting direction as the hitting direction data 558 (step S158), and finishes the batting operation determination process.

Again referring to FIG. 14, when the processing section 200 has finished the batting operation determination process, the processing section 200 refers to the batting start flag 552. When the batting start flag 552 is “1” (i.e., the bat has been swung) (YES in step S114), the processing section 200 determines whether or not the ball has been hit by the bat (step S116). For example, the processing section 200 may determine that the ball has been hit by the bat when the difference between the difference between the pitching start time 534 and the batting start time 554 and the reference time difference defined as the time difference from the time when the player gets good wood on the ball is within a given range.

When the batting start flag 552 is “0” (NO in step S114) or the processing section 200 has determined that the ball has not been hit by the bat (NO in step S116), the processing section 200 displays the movement of the ball (step S118), and determines whether or not the ball has reached the catcher (step S119). When the processing section 200 has determined that the ball has not reached the catcher (NO in step S119), the processing section 200 transitions to the step S112, and again executes the batting operation determination process. When the processing section 200 has determined that the ball has reached the catcher (YES in step S119), the processing section 200 transitions to the step S32 shown in FIG. 12.

When the processing section 200 has determined that the ball has been hit by the bat (YES in step S116), the processing section 200 executes the batted ball calculation process to calculate the direction and the travel distance of the batted ball (step S120), and executes the fielding process (step S122) in the same manner as in a known baseball game. In this case, the processing section 200 refers to the batting parameters 524. When “1” is stored as the bunt flag 556, the processing section 200 calculates the direction and the travel distance of the bunted ball.

Again referring to the flowchart shown in FIG. 12, the processing section 200 then executes the play result determination process (step S32).

The batting operation determination process according to this embodiment enables the player to easily change and set the position of the batter 8 by an intuitive operation merely by bringing the stylus pen 1416 into contact with the batting position mark 32 within the display range of the home plate 30 and dragging the stylus pen 1416. The player can sequentially input the batting start operation and the hitting direction input operation by bringing the stylus pen 1416 into contact with the batting position mark 32 and performing a stroke operation in the direction of the hitting direction guide 36R, 36C, or 36L at the desired timing. Specifically, an intuitive operation as if to swing the tip of the stylus pen 1416 as a bat can be implemented.

### Second Embodiment

A second embodiment to which the invention is applied is described below. The configuration according to this embodiment is basically the same as the configuration according to the first embodiment, but differs from the configuration according to the first embodiment as to the ball speed input method used for the pitching operation. Note that the elements described in the first embodiment are indicated by the same symbols. Description of these elements is omitted.

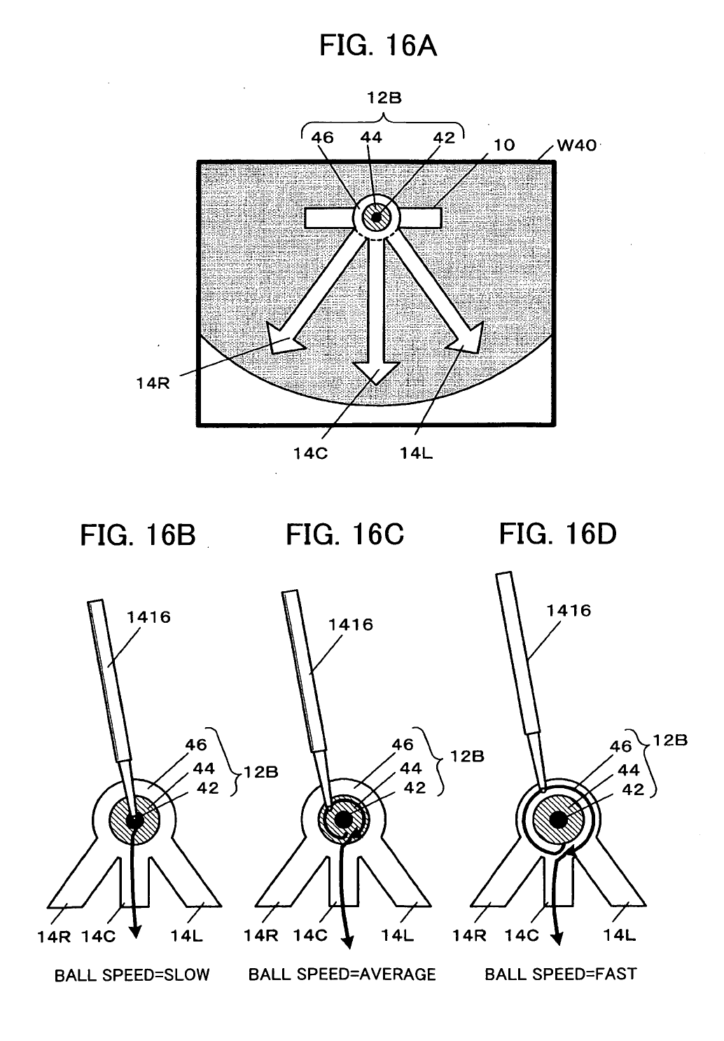

FIG. 16 is a schematic view illustrative of the ball speed input method according to this embodiment. As indicated by a pitching operation input screen W40 shown in FIG. 16A, a pitching position mark 12B according to this embodiment has a small circle section 42, a medium circle section 44, and a large circle section 46 that are positioned concentrically.

In this embodiment, when inputting the ball speed “slow”, as shown in FIG. 16B, the player brings the stylus pen 1416 into contact with the small circle section 42 of the pitching position mark 12B, draws a small circular path within the small circle section 42, performs the pitching start input operation by performing the first stroke operation along the pitching guide 14R, 14C, or 14L that corresponds to the desired pitching direction in the same manner as in the first embodiment, and then performs the ball direction change input operation by performing the second stroke operation, as required. The processing section 200 determines the size of the circular path that is drawn in a period from detection of contact with the pitching position mark 12B to detection of the first stroke operation. When the player has drawn a circular path having a diameter equal to or less than the diameter of the small circle section 42, the processing section 200 determines that the player has input the ball speed “slow”.

Note that the term “circular path” is not limited to a perfect circle, but may be distorted or may not form a completely closed curve.

Likewise, when inputting the ball speed “average”, the player brings the stylus pen 1416 into contact with the pitching position mark 12B, and performs the first stroke operation so as to draw a circular path having a diameter equal to or less than the diameter of the medium circle section 44 that is larger than the small circle section 42, as shown in FIG. 16C. When inputting the ball speed “fast”, the player brings the stylus pen 1416 into contact with the pitching position mark 12B, and performs the first stroke operation so as to draw a circular path having a diameter equal to or larger than the diameter of the medium circle section 44 and is equal to or less than the diameter of the large circle section 44 that is larger than the medium circle section 44, as shown in FIG. 16D.

The shape and the size of the path drawn on the touch panel 1409 may be determined using a known touch panel graphical input technology, character input identification technology, or the like.

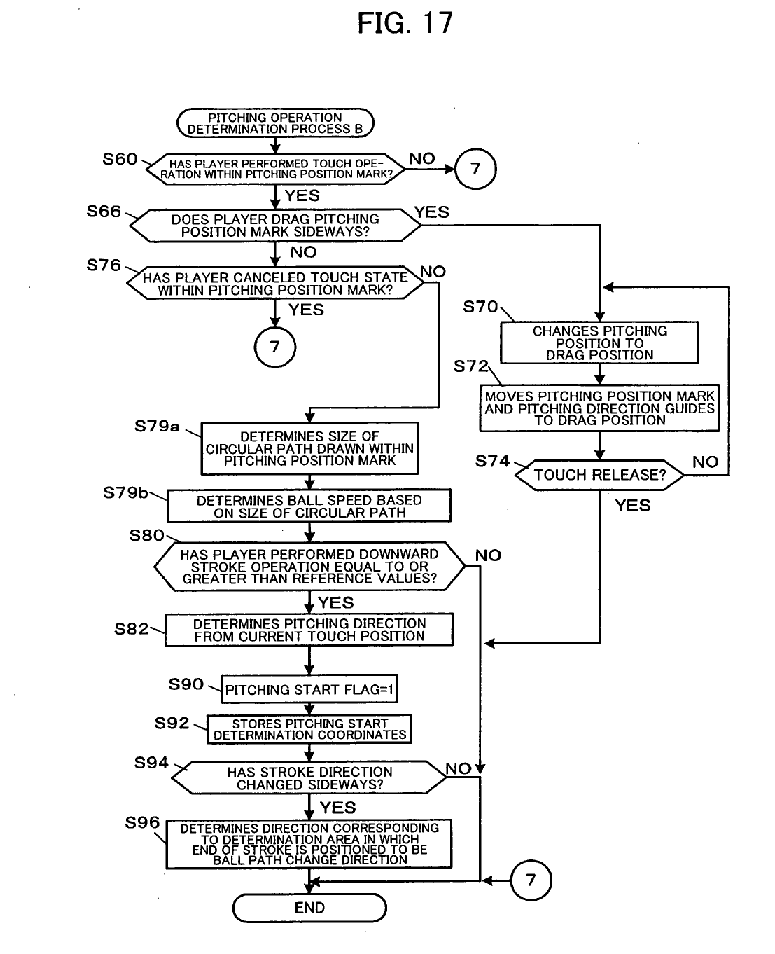

FIG. 17 is a flowchart illustrative of the flow of a pitching operation determination process B according to this embodiment. The flow of the pitching operation determination process B is basically the same as the flow of the pitching operation determination process according to the first embodiment, except that the process relating to the ball speed setting counter section 217 is omitted and step S79a and S79b are executed before the step S80. Specifically, the processing section 200 determines the size of the circular path drawn within the pitching position mark 12B (step S79a), and determines the ball speed based on the size of the circular path (step S79b).

According to this embodiment, since the player can input the ball speed by adjusting the size of a figure drawn after bringing the stylus pen 1416 into contact with the pitching position mark 12B, a more intuitive operation input can be implemented. Since the player need not perform a stroke operation at a speed corresponding to the ball speed, the player can quite easily perform the pitching operation even when the player repeats the pitching operation.

### Third Embodiment

In the second embodiment, the player draws a circular path within the pitching position mark when inputting the ball speed. Note that the path drawn by the player is not limited thereto. Moreover, a plurality of types of paths may be used.

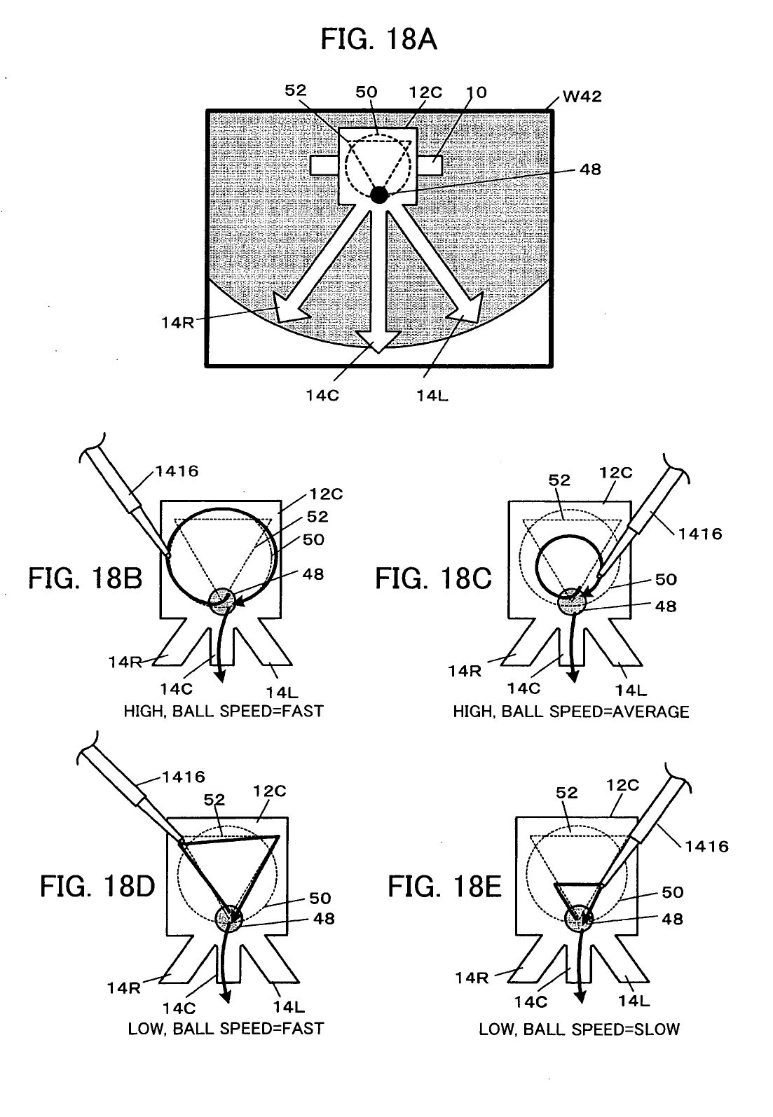

In a third embodiment, a pitching position mark 12C is formed as a rectangular area, and a drawing position guide 48 is displayed at the lower center of the rectangular area, as indicated by a ball operation input screen W42 shown in FIG. 18A, for example. The drawing position guide 48 is a drawing indicator appropriate for starting the pitching touch operation. A plurality of path guides 50 and 52 are drawn in the pitching position guide 12C over the rectangular area. In example shown in FIG. 18A, the guide 50 indicates a circular path guide, and the guide 52 indicates a downward triangular path guide.

As shown in FIG. 18B, when the player has drawn a circular path almost equal to the guide 50 within the pitching position mark 12C, the processing section 200 determines that the player has performed a high fastball input. As shown in FIG. 18C, when the player has drawn a circular path having a medium size, the processing section 200 determines that the player has performed a high fastball input. When the player has drawn a smaller circular path (not shown), the processing section 200 determines that the player has performed a high and slow ball input.

When the player has drawn a downward triangular path within the pitching position mark 12C, the processing section 200 determines that the player has performed a low ball input. The processing section 200 determines the ball speed based on the size of the path.

Specifically, when the player has drawn a downward triangular path almost equal to the guide 52 within the pitching position mark 12C (see FIG. 18D), the processing section 200 determines that the player has performed a low fastball input. As shown in FIG. 18E, when the player has drawn a small downward triangular path, the processing section 200 determines that the player has performed a slow ball input even if the type of path is identical. When the player has drawn a medium downward triangular path (not shown), the processing section 200 determines that the player has performed a low and average speed ball input.

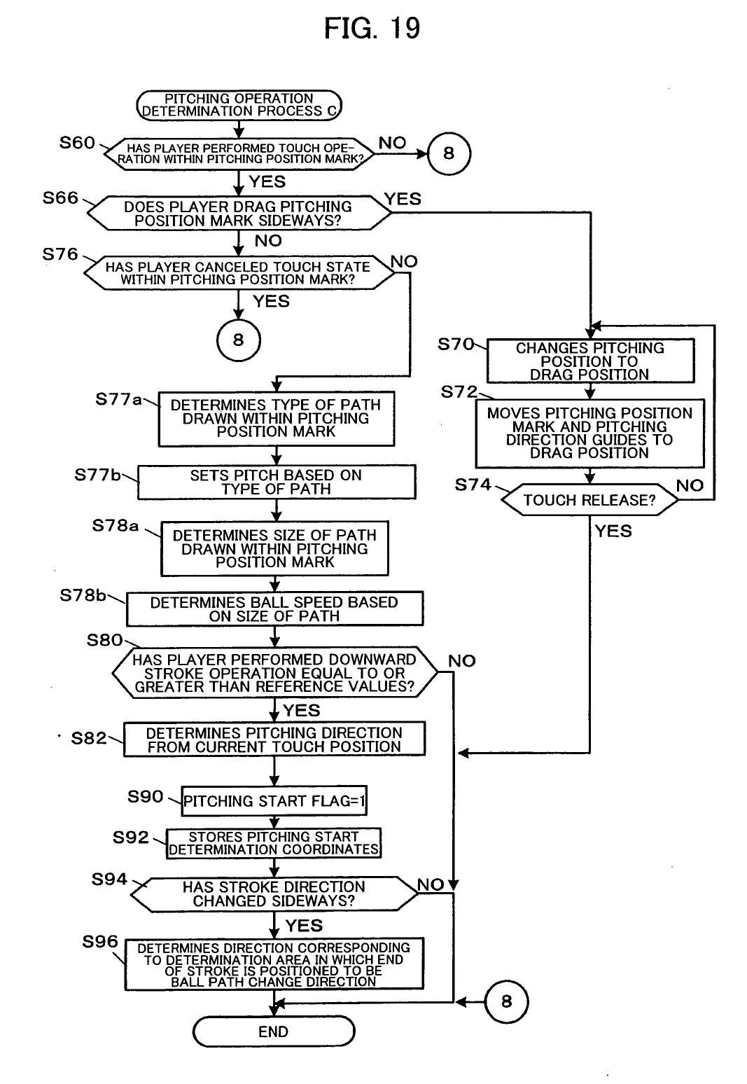

FIG. 19 shows the flow of a pitching operation determination process C according to the third embodiment, for example. Specifically, the processing section 200 executes a process that determines the type of path drawn within the pitching position mark 12C (step S77a) and a process that determines the pitch (high or low) based on the determined type of path (step S77b) before the step S79a of the pitching operation determination process according to the second embodiment. The process in the steps S79a and S79b of the pitching operation determination process according to the second embodiment is replaced by a process that determines the size of the path (step S78a) and determines the ball speed based on the size of the path (step S78b).

The movement control pattern set based on the type of path drawn within the pitching position mark may be appropriately set instead of the height/of a pitched ball.

Modification

The first to third embodiments to which the invention is applied have been described above. Note that the invention is not limited thereto. Various modifications may be appropriately made, such as adding other elements, omitting some of the elements, or changing some of the elements. Although the above embodiments have been described taking an example of executing the baseball game, the invention may be similarly applied to a game that requires the player to input size and direction when controlling the movement of a moving object, or a game in which the player hits a moving object. For example, the invention may be applied to a tennis game, a hockey game, a penalty kick sequence in a soccer game, and a golf game. The invention may also be applied to a role-playing game (RPG) that includes similar elements.

The bunt operation input method utilized in the batting operation method according to the above embodiments is not limited to the method that inputs a downward stroke operation from the home plate 30 using the stylus pen 1416.

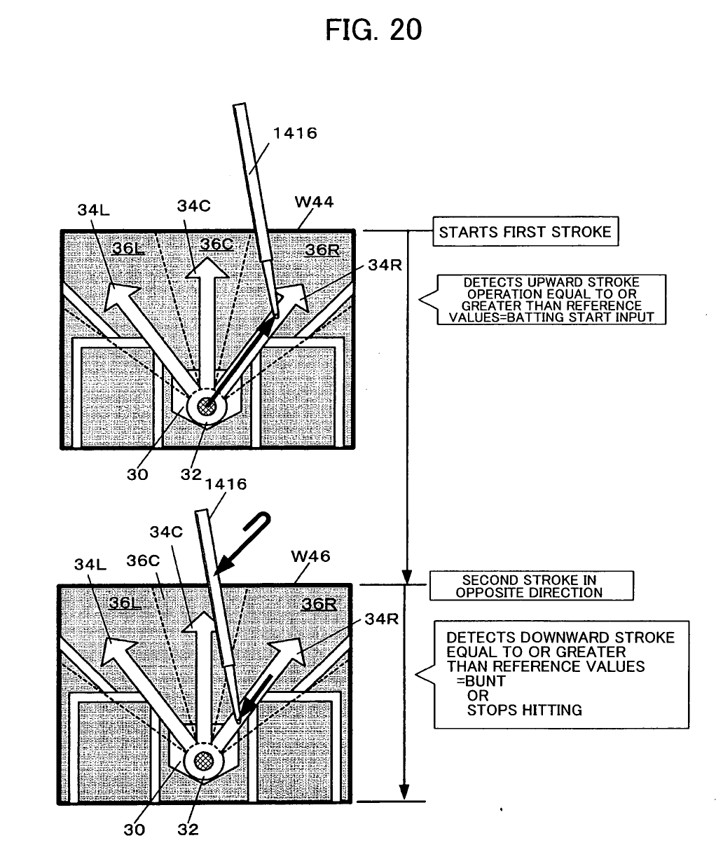

For example, as indicated by a batting operation input screen W44 shown in FIG. 20, the processing section 200 may determine that the player has input a bunt operation when the player has input the second stroke operation by reversing the stroke direction when inputting the first stroke operation along the hitting direction guide 34R, 34C, or 34L. In this case, since the hitting direction can be determined when determining the batting start input operation using the first stroke operation, the player can input the hitting direction even when bunting a ball.

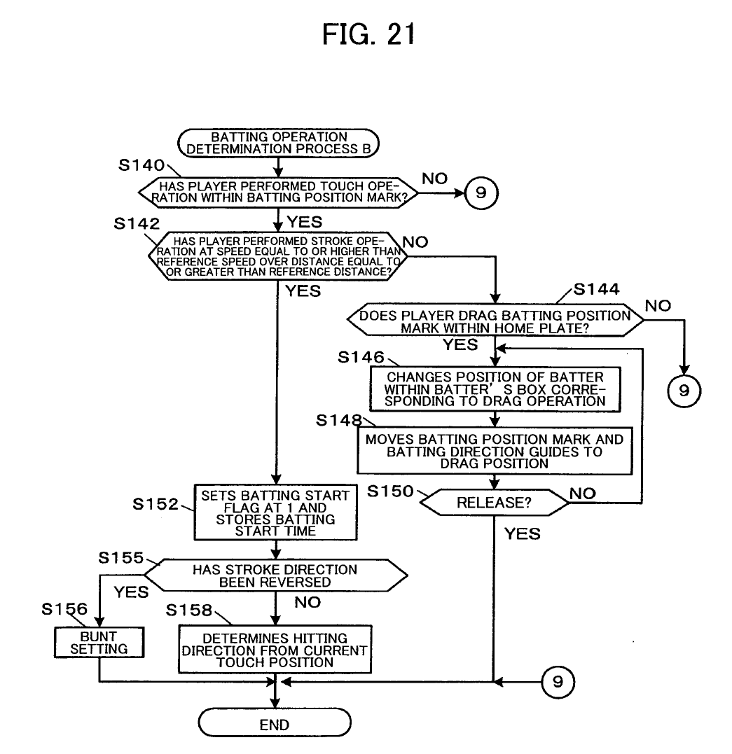

Specifically, as indicated by the flowchart of the batting operation determination process B shown in FIG. 21, a stroke direction reversal detection process is executed instead of the step S154 according to the first embodiment (step S155). When the processing section 200 has determined that the player has reversed the stroke direction (YES in step S155), the processing section 200 determines that the player has input a bunt operation (step S156).

The batting start operation may be canceled by utilizing the detection of the second stroke operation in the direction opposite to that of the first stroke operation.

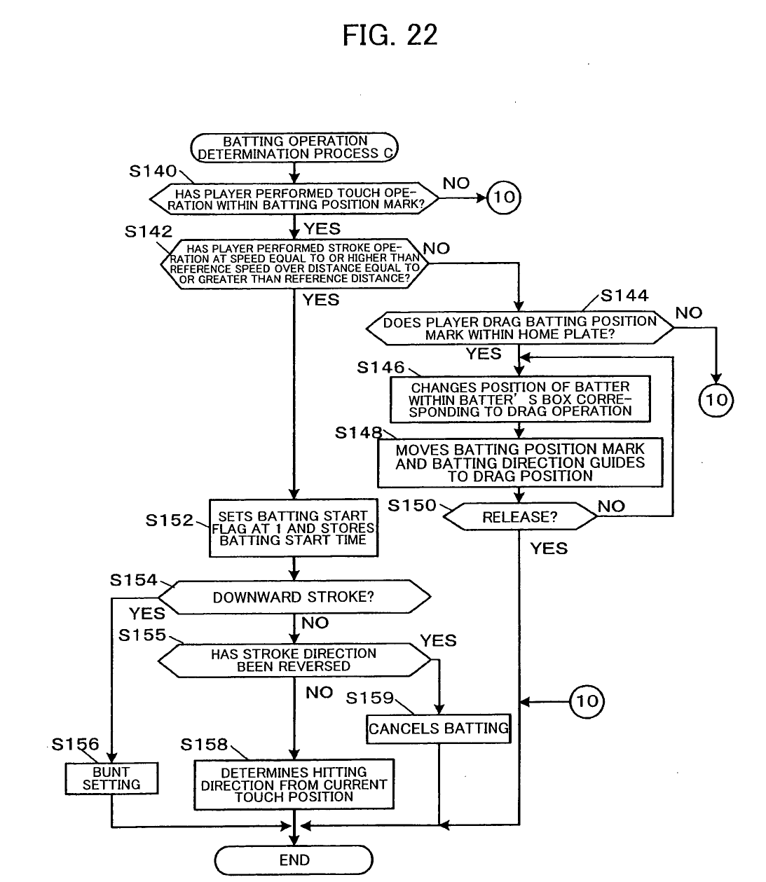

Specifically, as indicated by the flowchart of the batting operation determination process C shown in FIG. 22, when the processing section 200 has detected that the player has input the second stroke operation in the direction opposite to that of the first stroke operation after inputting the first stroke operation (YES in step S155), the first stroke operation determines that the player has stopped in mid-swing, sets the batting start flag 556 at “0” so that the batting start operation is canceled (step S158), disables batted ball movement control, and displays the movement of the ball (moving object) that travels from the pitcher to the catcher.

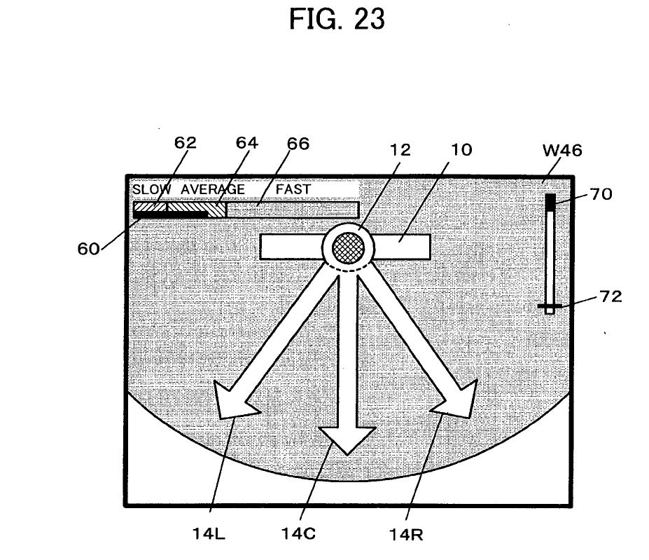

As indicated by a pitching operation input screen W46 shown in FIG. 23, when the player inputs the ball speed input operation according to the above embodiments, a gauge 60 that indicates the magnitude of the pitching operation input by a touch operation on the touch panel 1409, and a bar graph 70 that indicates the stroke length input by the first stroke operation, may be displayed.

In the first embodiment, a step that displays the gauge 60 so that the value increases corresponding to the counter value of the ball speed setting counter section 217 is added to the pitching operation determination process so that the magnitude of the currently input pitching operation is displayed, for example. The background of the gauge 60 is divided into three sections 62, 64, and 66 (“slow”, “average”, and “fast”) corresponding to the distance from the starting point (left end in FIG. 23). Therefore, the player can visually observe the ball speed that can be selected by the current input state. In the second and third embodiments, the brightness of the section corresponding to the ball speed determined in the pitching operation determination process may be increased, or the section corresponding to the determined ball speed may be caused to blink.

A process that calculates the distance between the operation position mark 12 and the current touch position and a process that displays the bar graph 70 corresponding to the calculated distance are added to the pitching operation determination process so that the player can observe the magnitude of the current stroke operation. It is desirable to display a target line 72 over the bar graph 70 at a position that corresponds to the reference distance (i.e., the determination reference of the pitching start input operation). In the example shown in FIG. 23, the bar graph 70 is displayed so that a black bar extends downward along a white frame.

The magnitude of the pitching operation may be output using effect sound.

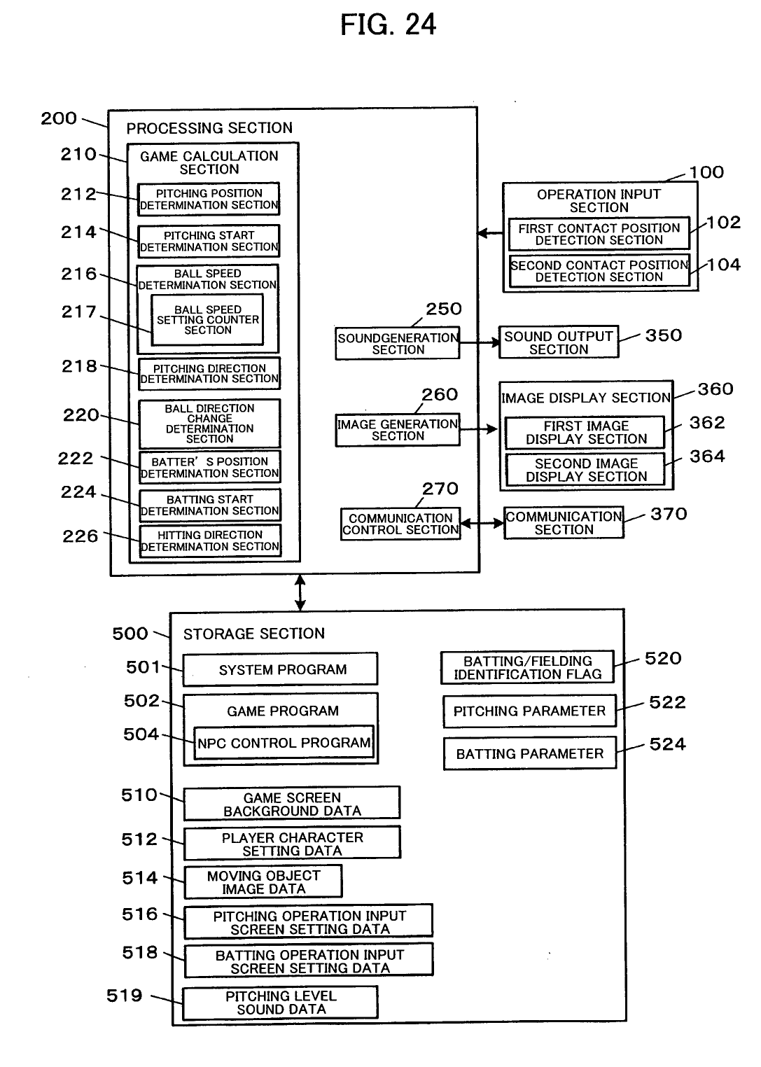

For example, pitching level sound data 519 is stored in the storage section 500 in advance, as shown in FIG. 24. A plurality of types of sound source data such as effect sound that differs in interval and tempo corresponding to the ball speed or pitching effect sound are stored as the pitching level sound data 519. The sound generation section 250 reads the sound source data corresponding to the ball speed determined in the pitching operation determination process, reproduces the sound source data to generate a sound signal, and outputs the sound signal to the sound output section 350. The sound output section 350 outputs sound corresponding to the magnitude of the pitching operation (i.e., ball speed) from the speaker 1410. This allows the player to aurally determine the ball speed corresponding to the current pitching operation input so that the operability is improved.

In the above embodiments, a plurality of image display devices (liquid crystal displays) are used, the game screen is displayed on one image display device, and the pitching operation input screen and the batting operation input screen are displayed on the other image display device. Note that the invention is not limited thereto. The game screen, the pitching operation input screen, and the batting operation input screen may be displayed on one liquid crystal display.

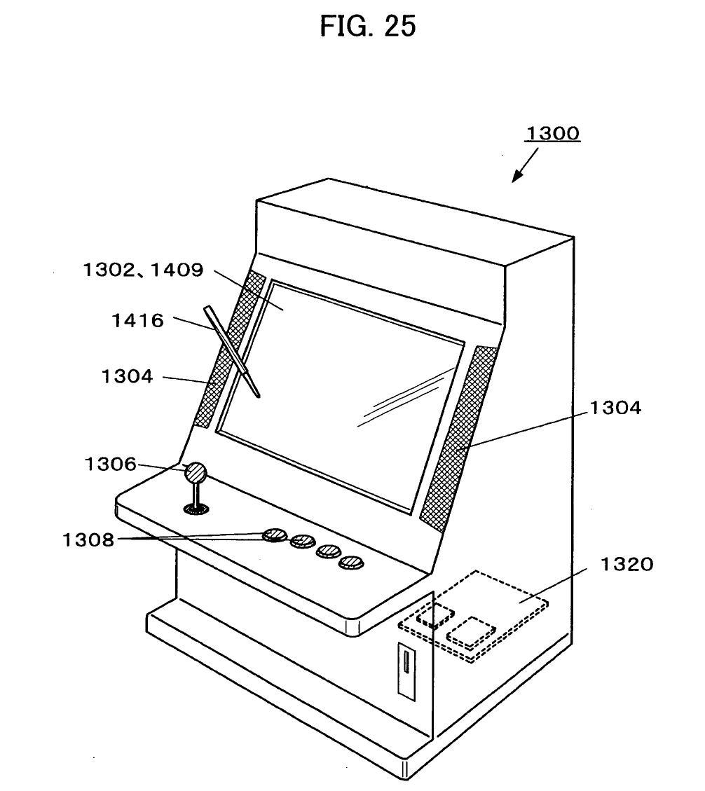

As shown in FIG. 25, an arcade game device 1300 that includes a single image display device 1302 in which the touch panel 1409 is integrally provided may be used, for example. The arcade game device 1300 includes the image display device 1302 that corresponds to the image display section 360, a speaker 1304 that corresponds to the sound output section 350, a joystick 1306 and a button switch 1308 that correspond to the operation input section 100, the touch panel 1409 provided on the image display surface of the image display device 1302, and a stylus pen 1416 used to input an operation on the touch panel 1409.

A control board 1320 that corresponds to the control unit 1450 according to the first embodiment is provided in a housing. The control board 1320 includes a CPU that executes game calculations and the like, an LSI (e.g., sound generation LSI and GPU), and an IC memory (e.g., RAM and ROM), and controls the operation of the entire arcade game device 1300. The control board 1320 corresponds to the processing section 200 and the storage section 500. The system program, the game program, and various types of data may be stored in the IC memory. Alternatively, a wireless communication module that corresponds to the communication section 370 may be provided in the same manner as in the first embodiment, and the system program and the like may be downloaded from an external device through a communication line.

The player enjoys the game by inputting various operations using the joystick 1306, the button switch 1308, and the stylus pen 1416 (for touch operation) while watching a game screen displayed on the image display device 1302 and listening to effect sound output from the speaker 1304, for example.

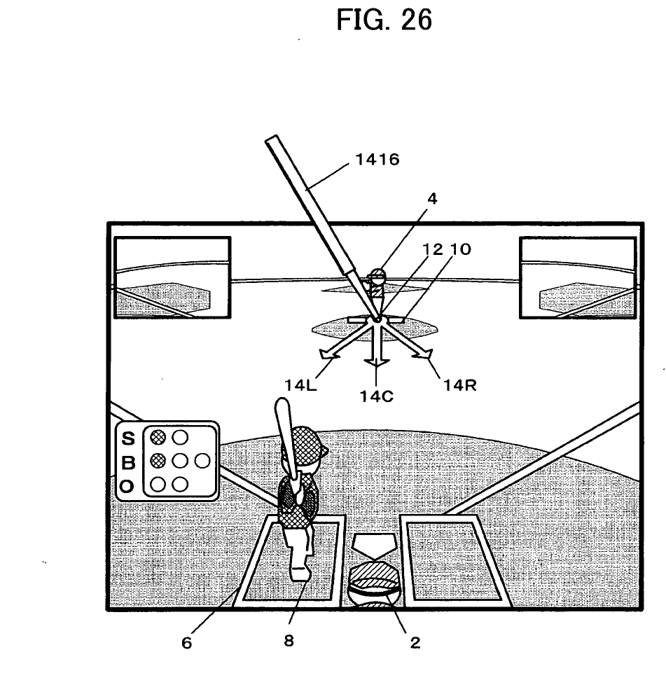

When the player's team plays defense, the pitching position mark 12 and the pitching direction guides 14R, 14C, and 14L may be displayed near the pitcher 4 displayed on the game screen W2 (see FIG. 2A) according to the first embodiment, as shown in FIG. 26. When the player's team plays offense, the batting position mark 32 and the hitting direction guides 34R, 34C, and 34L may be displayed near the home plate displayed on the game screen W20 (see FIG. 5A).

As hardware that executes the game, a consumer game device, a personal computer, a portable telephone, a PDA, and the like may be used insofar as a touch panel is provided.

A configuration that reflects various amounts of the pitching operation in the ball movement control method may be employed.

Specifically, the player character setting data 512 includes a pitching capability value, a location capability value, and a breaking ball capability value (pitching control capabilities) that are set as the capability values of each player in the same manner as in a known baseball game.

The pitching capability value corresponds to the maximum ball pitching capability. For example, the pitching capability value may be set using the maximum ball speed.

A player having a small location capability value has poor control, and a player having a large location capability value has good control.

A player having a large breaking ball capability value can pitch a breaking ball that changes in path to a large extent (i.e., the amount of change in moving path of a pitched ball is large).

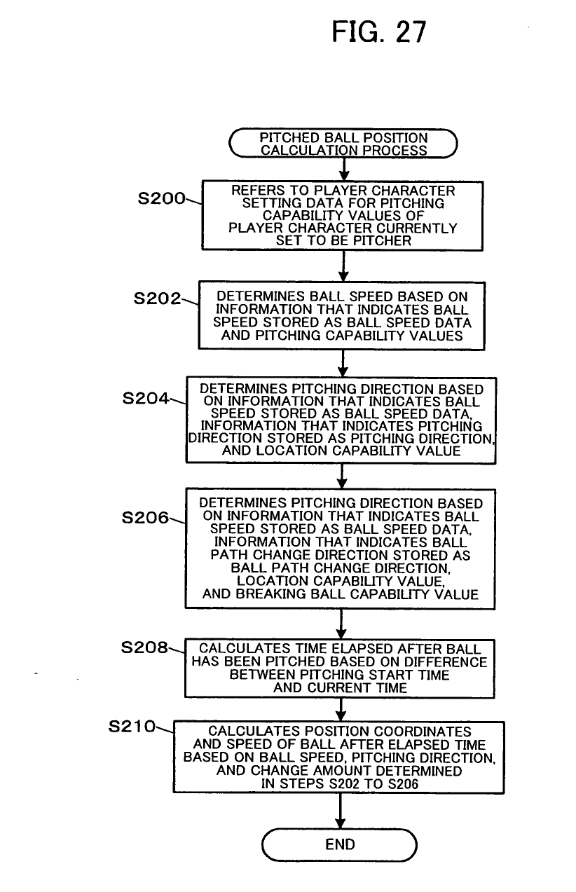

The step S18 (see FIG. 12) according to the first embodiment is executed as indicated by a flowchart illustrative of the flow of a pitched ball position calculation process shown in FIG. 27. In the pitched ball position calculation process, the processing section 200 refers to the player character setting data 512 for the pitching capability values of the player character currently set to be the pitcher (step S200).

The processing section 200 determines the ball speed based on information that indicates the ball speed stored as the ball speed data 540 and the pitching capability values (step S202). For example, when the ball speed is “slow”, the processing section 200 calculates a speed corresponding to 30% of the maximum ball speed based on the pitching capability value as the reference speed. When the ball speed is “average”, the processing section 200 calculates a speed corresponding to 50% of the maximum ball speed as the reference speed. When the ball speed is “fast”, the processing section 200 calculates a speed corresponding to 80% of the maximum ball speed as the reference speed. The processing section 200 sets a change value range corresponding to the capability value, determines the applied change value within the change value range based on random numbers, and determines the ball speed by adding the determined change value to the reference speed or subtracting the determined change value from the reference speed, for example.

The processing section 200 then determines the pitching direction based on information that indicates the ball speed stored as the ball speed data 540, information that indicates the pitching direction stored as the pitching direction 542 (see FIG. 10), and the location capability value (step S204).

For example, the processing section 200 determines the basic direction based on the information stored as the pitching direction 542. The processing section 200 sets a pitching direction change angle range so that the change angle range increases as the ball speed set as the ball speed data 540 and the location capability value increase, determines the applied change angle within the change angle range based on random numbers, and determines the pitching direction by adding the determined change angle to the reference direction or subtracting the determined change angle from the reference direction, for example.

The processing section 200 then determines the pitching direction based on information that indicates the ball path change direction stored as the ball path change direction 546 (see FIG. 10), the location capability value, and the breaking ball capability value (step S206).

For example, the processing section 200 determines the basic change amount based on the information stored as the ball path change direction 546. The processing section 200 sets a change amount range so that the change amount range increases as the breaking ball capability value of the pitcher increases and decreases as the location capability value decreases, determines the applied change amount within the change amount range based on random numbers, and determines the ball path change amount by adding the determined change amount to the reference change amount or subtracting the determined change amount from the reference change amount, for example.

The processing section 200 calculates the time elapsed after the ball has been pitched based on the difference between the pitching start time 534 and the current time (step S208), calculates the position coordinates and the speed of the ball after the elapsed time based on the ball speed, the pitching direction, and the change amount determined in the steps S202 to S206 (step S210) in the same manner as in a known baseball game, and finishes the pitched ball position calculation process. A physical calculation expression may be used as a calculation expression, or a simple expression that is appropriately created may be used.

The ball speed and the pitching direction may be determined based on the moving speed and the moving amount of the first stroke operation without referring to the ball speed data 540.

Specifically, a step that calculates the moving speed (maximum speed or average speed) of the first stroke operation and stores the moving speed of the first stroke operation in the storage section 500 as one of the pitching parameters 522 is added to the pitching operation determination process between the steps S80 and S94, and a step that stores the coordinates of the end position of the first stroke operation in the storage section 500 as one of the pitching parameters 522 is added after the step S94. The distance between the coordinates of the end position of the first stroke operation and the pitching start determination coordinates 544 (see FIG. 10) corresponds to the moving amount. The ball speed change value range and the pitching direction change angle range are increased in the steps S202 and S204 as the moving speed and the moving amount of the first stroke operation increase, instead of, or in addition to, referring to the ball speed data 540.

The ball speed and the pitching direction may be determined based on the moving speed and the moving amount of the second stroke operation without referring to the ball speed data 540. In this case, a step that calculates the moving speed (maximum speed or average speed) of the second stroke operation and stores the moving speed of the second stroke operation in the storage section 500 as one of the pitching parameters 522 is added to the pitching operation determination process after the step S94, and a step that stores the coordinates of the end position of the second stroke operation in the storage section 500 as one of the pitching parameters 522 is added after the step S96. The distance between the coordinates of the end position of the second stroke operation and the pitching start determination coordinates 544 corresponds to the moving amount. The ball speed change value range and the pitching direction change angle range are increased in the steps S202 and S204 as the moving speed and the moving amount of the second stroke operation increase, instead of, or in addition to, referring to the ball speed data 540.

In the above embodiments, the ball path change direction is determined in the pitching operation determination process by utilizing a change in stroke direction from that of the first stroke operation in an amount equal to or larger than the reference value (step S94 in FIG. 12, for example). Note that the ball path change direction may be determined based on whether the touch position is positioned in the determination area 18R or 18L when the player maintains the touch position at an approximately identical position for a given period of time after pitching start determination.

Specifically, a process that calculates the moving amount of the touch position in a period between the preceding pitching operation determination process and the current pitching operation determination process after pitching start determination, and a process that measures the time until the touch state is canceled when the calculated moving amount is equal to or smaller than a reference moving amount that indicates a stationary state are executed instead of the step S94. The step S96 is executed when the measured time is equal to or greater than a given reference time (e.g., one second or more).

Specifically, the player can input the ball path change direction merely by stopping the stylus pen 1416 at the end of the first stroke operation and moving the touch position to the determination area 18R or 18L. According to this method, since the touch position is not maintained when the player performs the first stroke operation to full swing, the process in the step S96 is not executed. Therefore, the information stored as the ball path change direction 546 (see FIG. 10) corresponds to “no change” (initial state). As a result, the pitcher pitches a fastball.

It is desirable to set the determination areas 18R and 18L under the pitching position mark 12 on either side of the pitching position mark 12 as the center. This allows the player to easily determine the boundary between the determination areas.

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention.

What is claimed is:

1. A method comprising:
determining start of a stroke operation performed on a touch panel;
determining a magnitude of an operation input based on a time elapsed until the stroke operation is performed after a touch operation has been performed on the touch panel;
determining a direction based on the stroke operation; and
controlling movement of a given moving object displayed on a screen using the determined magnitude and the determined direction.

2. The method as defined in claim 1,
the controlling of the movement of the moving object including variably controlling a moving speed of the moving object based on the determined magnitude.

3. The method as defined in claim 1, further comprising:
determining that the stroke operation has started when a touch position has changed in an amount outside a given allowable range.

4. The method as defined in claim 1, further comprising:
determining a second direction based on a touch position after the stroke operation has started; and
changing a moving direction of the moving object to the second direction.

5. The method as defined in claim 4, further comprising:
determining the second direction based on a change direction of the touch position after the stroke operation has started.

6. The method as defined in claim 4, further comprising:
changing the second direction based on an amount of change in the touch position after the stroke operation has started.

7. The method as defined in claim 4, further comprising:
determining the second direction based on the touch position when the touch position is situated at an approximately identical position for a given period of time after the stroke operation has started.

8. The method as defined in claim 4, further comprising:
determining a degree of change in the moving direction of the moving object to the second direction using the determined magnitude.

9. The method as defined in claim 1, further comprising:
displaying a display object that indicates the determined magnitude.

10. The method as defined in claim 1, further comprising:
variably outputting effect sound based on the determined magnitude.

11. A method comprising:
displaying a touch start position indicator on a display section that includes a touch panel;
determining a magnitude of an operation input based on a moving path of a touch position within the touch start position indicator;
determining start of a stroke operation performed on the touch panel;
determining a direction based on the stroke operation; and
controlling movement of a given moving object displayed on a screen using the determined magnitude and the determined direction.

12. The method as defined in claim 11, further comprising:
determining a shape of the moving path; and
selecting a movement control pattern from a plurality of movement control patterns based on the determined shape, and controlling the movement of the moving object according to the selected movement control pattern.

13. The method as defined in claim 1, further comprising:
displaying a magnitude indicator based on the determined magnitude.

14. The method as defined in claim 11, further comprising:
displaying a magnitude indicator based on the determined magnitude.

15. The method as defined in claim 1, further comprising:
changing a moving direction of the moving object based on a magnitude of the stroke operation.

16. The method as defined in claim 11, further comprising:
changing a moving direction of the moving object based on a magnitude of the stroke operation.

17. A computer-readable storage medium storing a program that causes a computer to execute the method as defined in claim 1.

18. A computer-readable storage medium storing a program that causes a computer to execute the method as defined in claim 11.

19. A game device comprising:
a stroke start determination section that determines start of a stroke operation performed on a touch panel;
a magnitude determination section that determines a magnitude of an operation input based on a time elapsed until the stroke operation is performed after a touch operation has been performed on the touch panel;
a direction determination section that determines a direction based on the stroke operation; and
a movement control section that controls movement of a given moving object displayed on a screen using the determined magnitude and the determined direction.

20. A game device comprising:
a touch start position indicator display control section that displays a touch start position indicator on a display section that includes a touch panel;
a magnitude determination section that determines a magnitude of an operation input based on a moving path of a touch position within the touch start position indicator;
a stroke start determination section that determines start of a stroke operation performed on the touch panel;
a direction determination section that determines a direction based on the stroke operation; and
a movement control section that controls movement of a given moving object displayed on a screen using the determined magnitude and the determined direction.
